(19) United States
(12) Patent Application Publication
(10) Pub. No.: US 2008/0300100 A1
(43) Pub. Date: Dec. 4, 2008

(54) Control apparatus for vehicular power transmitting system

(75) Inventors: Tooru Matsubara, Toyota-shi (JP); Atsushi Tabata, Okazaki-shi (JP); Taku Akita, Kasugai-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/153,335

(22) Filed: May 16, 2008

(30) Foreign Application Priority Data
May 29, 2007 (JP) 2007-141588

(51) Int. Cl. B60W 10/12

(52) U.S. Cl. 477/5

(57) ABSTRACT

A control apparatus for a vehicular power transmitting system including (a) an electrically controlled differential portion which has a differential mechanism and a first electric motor operatively connected to a rotary element of the differential mechanism and which is operable to control a differential state between a rotating speed of its input shaft connected to a drive power source and a rotating speed of its output shaft by controlling an operating state of the first electric motor, (b) a transmission portion (20) constituting a part of a power transmitting path between the electrically controlled differential portion and a drive wheel of a vehicle, and (c) a second electric motor connected to the power transmitting path, the control apparatus including a feedback control inhibiting portion configured to inhibit a feedback control of the first electric motor according to an operating speed of the second electric motor, upon concurrent shifting actions of the electrically controlled differential portion and the transmission portion.

### CROSS REFERENCE TO RELATED APPLICATION

The present application claims priority from Japanese Patent Application No. 2007-141588, which was filed on May 29, 2007, the disclosure of which is herein incorporated by reference in its entirety.

### BACKGROUND OF THE INVENTION

1. Field of the Invention

The present invention relates in general to a control apparatus for a vehicular power transmitting system, and more particularly to a control apparatus for a hybrid vehicle power transmitting system including an electrically controlled differential portion and a transmission portion.

2. Discussion of Prior Art

There is known a hybrid vehicle including (a) an electrically controlled differential portion which includes a differential mechanism and a first electric motor connected to a rotary element of the differential mechanism and which is operable to control a differential state between rotating speeds of its input shaft connected to the engine and a rotating speed of its output shaft by controlling an operating state of the first electric motor, and (b) a second electric motor connected to a power transmitting path between the electrically controlled differential portion and a drive wheel of a vehicle. JP-2000-197208A discloses an example of a control apparatus for such a hybrid vehicle. This publication discloses techniques for calculating an estimated operating speed of the engine on the basis of a required vehicle drive force and a highest fuel-economy curve, and determining output torques of the first and second electric motors according to the estimated engine speed.

When a shift-down action of the electrically controlled differential portion, for example, the operating speed of the first electric motor is controlled in a feedback fashion according to the operating speed of the second electric motor. In the hybrid vehicle disclosed in the above-identified publication, however, the feedback control of the operating speed of the first electric motor is implemented without taking account of a change of the operating speed of the second electric motor in the process of a shift-down action of the transmission portion, so that the feedback-controlled speed of the first electric motor cannot follow the operating speed of the second electric motor with a high response, due to a rapid change of the speed of the second electric motor in an inertia phase of the shift-down action of the transmission portion. Accordingly, an unnecessary change of the operating speed of the first electric motor may occur in the inertia phase of the shift-down action of the transmission portion. This drawback has not been addressed in the prior art and need to be solved as soon as possible.

A collinear chart of FIG. 14 indicates a change of the operating speed of the first electric motor M1 of an electrically controlled differential portion from a point “a” to a point “b” due to a shift-down action of the electrically controlled differential portion, and a change of the operating speed of the first electric motor (M1) from the point “b” to a point “c” due to a shift-down action of a transmission portion (A/T) from a fourth gear position to a third gear position, where the shift-down action of the differential portion and the shift-down action of the transmission portion take place concurrently. Since the direction of the speed change of the first electric motor (M1) from the point “a” to the point “b” and the direction of the speed change from the point “b” to the point “c” are opposite to each other, the first electric motor suffers from an unnecessary change of its speed, so that an input torque of the transmission portion (A/T) varies, giving rise to a considerable shifting shock of the transmission portion.

### SUMMARY OF THE INVENTION

The present invention was made in view of the background art described above. It is therefore an object of this invention to provide a control apparatus for a vehicular power transmitting system including an electrically controlled differential portion and a transmission portion, which control apparatus is configured to reduce an unnecessary change of the first electric motor of the differential portion for reducing the shifting shock of the transmission portion.

The object indicated above can be achieved according to any one of the following modes of this invention, each of which is numbered like the appended claims and which depends from the other mode or modes, where appropriate, for easier understanding of technical features disclosed in the present application, and combinations of those features.

(1) A control apparatus for a vehicular power transmitting system including (a) an electrically controlled differential portion which has a differential mechanism and a first electric motor operatively connected to a rotary element of the differential mechanism and which is operable to control a differential state between a rotating speed of its input shaft connected to a drive power source and a rotating speed of its output shaft by controlling an operating state of the first electric motor, (b) a transmission portion constituting a part of a power transmitting path between the electrically controlled differential portion and a drive wheel of a vehicle, and (c) a second electric motor connected to the power transmitting path, the control apparatus comprising:
a feedback control inhibiting portion configured to inhibit a feedback control of the first electric motor according to an operating speed of the second electric motor, upon concurrent shifting actions of the electrically controlled differential portion and the transmission portion.

In the control apparatus of the above-described mode (1) according to a first aspect of the present invention, the feedback control of the first electric motor according to the operating speed of the second electric motor is inhibited during the concurrent shifting actions of the electrically controlled differential portion and the transmission portion, making it possible to prevent an unnecessary change of the operating speed of the first electric motor by the feedback control, which would take place due to a rapid change of the operating speed of the second electric motor in an inertia phase of the shifting action of the transmission portion. Thus, the present control apparatus is configured to reduce a variation of an input shaft torque of the transmission portion, and a shifting shock of the transmission portion.

(2) The control apparatus according to the above-described mode (1), further comprising a motor speed control portion configured to control an operating speed of the first electric motor so as to reduce an amount of change of the operating speed of the first electric motor during the concurrent shifting actions, on the basis of an estimated operating speed of the second electric motor upon completion of the shifting action of the transmission portion and an estimated operating speed of the drive power source upon completion of the shifting action of the transmission portion.

In the above-described mode (2) of the invention, the operating speed of the first electric motor is controlled so as to reduce the amount of change of the operating speed during the shifting actions of the differential portion and the transmission portion, making it possible to effectively reduce the unnecessary change of the operating speed of the first electric motor, so that the amount of the input torque variation of the transmission portion is minimized to reduce the shifting shock of the transmission portion.

(3) The control apparatus according to the above-described mode (2), wherein the motor speed control portion is configured to change a manner of controlling the first electric motor after an entry of an inertia phase of the shifting action of the transmission portion.

In the above-described mode (3) of this invention wherein the manner of controlling the first electric motor is changed after the entry of the inertia phase of the shifting action of the transmission portion, the operating speed of the first electric motor can be controlled to the estimated operating speed upon completion of the shifting action, after the entry or initiation of the inertia phase of the shifting action, while preventing an unnecessary change of the operating speed of the first electric motor.

(4) The control apparatus according to the above-described mode (2) or (3), wherein the motor speed control portion is configured to hold the operating speed of the first electric motor at a predetermined value until the shifting action of the transmission portion has entered an inertia phase, if a direction of an estimated change of the operating speed of the first electric motor during the above-indicated concurrent shifting actions is different from a direction of an estimated change of the operating speed of the drive power source during the concurrent shifting actions.

In the above-described mode (4), the operating speed of the first electric motor is held at the predetermined value until the shifting action of the transmission portion has entered the inertia phase, if the direction of the estimated change of the operating speed of first electric motor during the concurrent shifting actions is different from the direction of the estimated change of the operating speed of the drive power source during the concurrent shifting actions. Accordingly, the operating speed of the first electric motor can be smoothly changed while minimizing the amount of change, from a moment of initiation of the concurrent shifting actions to a moment of completion of the concurrent shifting actions, so that the shifting shock of the transmission portion can be reduced.

(5) The control apparatus according to any one of the above-described modes (2)-(4), wherein the motor speed control portion is configured to change the operating speed of the first electric motor at a predetermined rate until the shifting action of the transmission portion has entered an inertia phase, if a direction of an estimated change of the operating speed of the first electric motor during the above-indicated concurrent shifting actions is the same as a direction of an estimated change of the operating speed of the drive power source during the concurrent shifting actions.

In the above-described mode (5) of the present invention, the operating speed of the first electric motor is changed at the predetermined rate until the shifting action of the transmission portion has entered the inertia phase, if the direction of the estimated change of the operating speed of the first electric motor during the concurrent shifting actions is the same as the direction of the estimated change of the operating speed of the drive power source during the concurrent shifting actions. Accordingly, the operating speed of the first electric motor can be smoothly changed while minimizing the amount of change, from a moment of initiation of the concurrent shifting actions to a moment of completion of the concurrent shifting actions, so that the shifting shock of the transmission portion can be reduced.

(6) The control apparatus according to any one of the above-described modes (2)-(5), wherein the motor speed control portion is configured to change the operating speed of the first electric motor according to the operating speed of the second electric motor after the shifting action of the transmission portion has entered an inertia phase.

In the above-described mode (6), the operating speed of the first electric motor is controlled according to the operating speed of the second electric motor after the shifting action of the transmission portion has entered an inertia phase. Accordingly, the operating speed of the first electric motor after the entry of the inertia phase can be smoothly changed to the estimated value upon completion of the concurrent shifting actions, so that an unnecessary change of the operating speed of the first electric motor is reduced to reduce the shifting shock of the transmission portion.

(7) The control apparatus according to any one of the above described modes (1)-(6), wherein the electrically controlled differential portion is operable as a continuously-variable transmission mechanism while the operating state of the first electric motor is controlled.

In the above-described mode (7) of the invention wherein the electrically controlled differential portion is operable as the continuously-variable transmission mechanism while the operating state of the first electric motor is controlled, a drive torque of the vehicle can be smoothly changed. The electrically controlled differential portion is operable not only as an electrically controlled continuously variable transmission the speed ratio of which is continuously variable, but also as a step-variable transmission the speed ratio of which is variable in steps, so that an overall speed ratio of the vehicular power transmitting system can be varied in steps, for rapidly changing the vehicle drive torque.

(8) The control apparatus according to any one of the above-described modes (1)-(7), wherein the differential mechanism is a planetary gear set having three rotary elements consisting of a carrier connected to the input shaft of the electrically controlled differential portion and the drive power source, a sun gear connected to the first electric motor, and a ring gear connected to the output shaft of the electrically controlled differential portion.

In the above-described mode (8) of the present invention, the differential mechanism consisting of the single planetary gear set can be simplified in construction, and the required axial dimension of the differential mechanism can be reduced.

(9) The control apparatus according to the above-described mode (8), wherein the planetary gear set is a single-pinion type planetary gear set.

In the above-described mode (9), the differential mechanism consisting of the single single-pinion type planetary gear set can be simplified in construction, and the required axial dimension of the planetary gear set can be reduced.

(10) The control apparatus according to any one of the above-described modes (1)-(9), wherein the vehicular power transmitting system has an overall speed ratio defined by a speed ratio of the transmission portion and a speed ratio of the electrically controlled differential portion.

In the above-described mode (10), the vehicle drive force can be obtained over a wide range of speed ratio, by changing the speed ratio of the transmission portion as well as the speed ratio of the differential portion.

(11) The control apparatus according to any one of the above-described modes (1)-(10), wherein the transmission portion is a mechanical automatic transmission.

In the above-described mode (11), the electrically controlled differential portion functioning as an electrically controlled continuously variable transmission cooperates with the mechanical automatic transmission to constitute a continuously variable transmission mechanism which is operable to smoothly change the vehicle drive torque. When the speed ratio of the electrically controlled differential portion is controlled to be held constant, the electrically controlled differential portion and the transmission portion cooperate with each other to constitute a step-variable transmission mechanism the overall speed ratio of which is variable in steps, permitting a rapid change of the vehicle drive torque.

(12) A control apparatus for a vehicular power transmitting system including (a) an electrically controlled differential portion which has a differential mechanism and a first electric motor operatively connected to a rotary element of the differential mechanism and which is operable to control a differential state between a rotating speed of its input shaft connected to a drive power source and a rotating speed of its output shaft by controlling an operating state of the first electric motor, (b) a transmission portion constituting a part of a power transmitting path between the electrically controlled differential portion and a drive wheel of a vehicle, and (c) a second electric motor connected to the power transmitting path, the control apparatus comprising:
a feedback control inhibiting portion configured to inhibit a feedback control of the first electric motor according to an operating speed of the second electric motor, when shifting actions of the electrically controlled differential portion and the transmission portion that cause a movement of an operating point of the drive power source take place.

In the control apparatus of the above-described mode (12) according to a second aspect of the present invention, the feedback control of the first electric motor according to the operating speed of the second electric motor is inhibited during the shifting actions of the electrically controlled differential portion and the transmission portion that cause a movement of the operating point of the drive power source. Accordingly, the control apparatus makes it possible to prevent an unnecessary change of the operating speed of the first electric motor by the feedback control, which would take place due to a rapid change of the operating speed of the second electric motor during the shifting actions that causes the movement of the operating point of the drive power source. Thus, the present control apparatus is configured to reduce a variation of an input shaft torque of the transmission portion, and a shifting shock of the transmission portion.

(13) The control apparatus according to the above-described mode (12), further comprising a motor speed control portion configured to control an operating speed of the first electric motor so as to reduce an amount of change of the operating speed of the first electric motor during the shifting actions of the electrically controlled differential portion and the transmission portion, on the basis of an estimated operating speed of the second electric motor upon completion of the shifting action of the transmission portion and an estimated operating speed of the drive power source upon completion of the shifting action of the transmission portion.

The above-described mode (19) has the same advantage as described above with respect to the above-described mode (2).

(14) The control apparatus according to the above-described mode (13), wherein the motor speed control portion is configured to change a manner of controlling the first electric motor after an entry of an inertia phase of the shifting action of the transmission portion.

The above-described mode (14) has the same advantage as described above with respect to the above-described mode (3).

(15) The control apparatus according to the above-described mode (13) or (14), wherein the motor speed control portion is configured to hold the operating speed of the first electric motor at a predetermined value until the shifting action of the transmission portion has entered an inertia phase, if a direction of an estimated change of the operating speed of the first electric motor during the shifting actions of the electrically controlled differential portion and the transmission portion is different from a direction of an estimated change of the operating speed of the drive power source during the shifting actions.

The above-described mode (15) has the same advantage as described above with the above-described mode (4).

(16) The control apparatus according to any one of the above-described modes (13)-(15), wherein the motor speed control portion is configured to change the operating speed of the first electric motor at a predetermined rate until the shifting action of the transmission portion has entered an inertia phase, if a direction of an estimated change of the operating speed of the first electric motor during the shifting actions of the electrically controlled differential portion and the transmission portion is the same as a direction of an estimated change of the operating speed of the drive power source during the shifting actions.

The above-described mode (16) has the same advantage as described above with respect to the above-described mode (5).

(17) The control apparatus according to any one of the above-described modes (13)-(16), wherein the motor speed control portion is configured to control the operating speed of the first electric motor according to the operating speed of the second electric motor after the shifting action of the transmission portion has entered an inertia phase.

The above-described mode (17) has the same advantage as descried above with respect to the above-described mode (6).

(18) The control apparatus according to any one of the above-described modes (12)-(17), wherein the electrically controlled differential portion is operable as a continuously-variable transmission mechanism while the operating state of the first electric motor is controlled.

The above-described mode (18) has the same advantage as described above with respect to the above-described mode (7).

(19) The control apparatus according to any one of the above-described modes (12)-(18), wherein the differential mechanism is a planetary gear set having three rotary elements consisting of a carrier connected to the input shaft of the electrically controlled differential portion and the drive power source, a sun gear connected to the first electric motor, and a ring gear connected to the output shaft of the electrically controlled differential portion.

The above-described mode (19) has the same advantage as described above with respect to the above-described mode (8).

(20) The control apparatus according to the above-described mode (19), wherein the planetary gear set is a single-pinion type planetary gear set.

The above-described mode (20) of this invention has the same advantage as described above with respect to the above-described mode (9).

(21) The control apparatus according to any one of the above described modes (12)-(20), wherein the power transmitting system has an overall speed ratio defined by a speed ratio of the transmission portion and a speed ratio of the electrically controlled differential portion.

The above-described mode (21) has the same advantage as described above with respect to the above described mode (10).

(22) The control apparatus according to any one of the above-descried modes (12)-(21), wherein the transmission portion is a mechanical automatic transmission.

The above-described mode (22) has the same advantage as described above with respect to the above-described mode (11).

### BRIEF DESCRIPTION OF THE DRAWINGS

The above and other objects, features, advantages, and technical and industrial significance of this invention will be better understood by reading the following detailed description of a preferred embodiment of the present invention, when considered in connection with the accompanying drawings, in which:

FIG. 1 is a schematic view showing an arrangement of a power transmitting system of a hybrid vehicle, which is controlled by a control apparatus constructed according to one embodiment of this invention;

FIG. 2 is a table indicating shifting actions of an automatic transmission portion provided in the power transmitting system of FIG. 1, in relation to different combinations of operating states of hydraulically operated frictional coupling devices to effect the respective shifting actions;

FIG. 3 is a collinear chart indicating relative rotating speeds of rotary elements of an electrically controlled differential portion and the automatic transmission portion of the power transmitting system of FIG. 1;

FIG. 4 is a view indicating input and output signals of an electronic control device serving as the control apparatus according to the embodiment of this invention to control the power transmitting system of FIG. 1;

FIG. 5 is a circuit diagram showing hydraulic actuators provided in a hydraulic control unit, for operating clutches C and brakes B incorporated in the automatic transmission portion, and linear solenoid valves for controlling the hydraulic actuators;

FIG. 6 is a view showing an example of a manually operated shifting device including a shift lever and operable to select one of a plurality of shift positions;

FIG. 7 is a functional block diagram illustrating major control functions of the electronic control device of FIG. 4;

FIG. 8 is a view illustrating an example of a stored shifting boundary line map used for determining a shifting action of the automatic transmission portion, and an example of a stored drive-power-source switching boundary line map used for switch a vehicle drive mode between an engine drive mode and a motor drive mode, the shifting and switching boundary line maps being defined in the same two-dimensional coordinate system, in relation to each other;

FIG. 9 is a view illustrating an example of a fuel consumption map defining a highest-fuel-economy curve of an engine (indicated by broken line);

FIG. 10 is a time chart for explaining one example of power-on shift-down actions of the differential portion and the automatic transmission portion, which take place when an accelerator pedal is depressed;

FIG. 11 is a time chart for explaining another example of the power-on shift-down actions of the differential portion and the automatic transmission portion, which take place when the accelerator pedal is depressed;

FIG. 12 is a flow chart illustrating a control routine executed by the electronic control device of FIG. 4, for reducing an unnecessary change of the operating speed of a first electric motor of the differential portion to reduce a shifting shock of the automatic transmission portion, when the shift-down actions of the differential portion and the automatic transmission portion take place concurrently; and

FIG. 13 is a collinear chart of the electrically controlled differential portion, which corresponds to that of FIG. 3.

### DETAILED DESCRIPTION OF THE PREFERRED EMBODIMENT

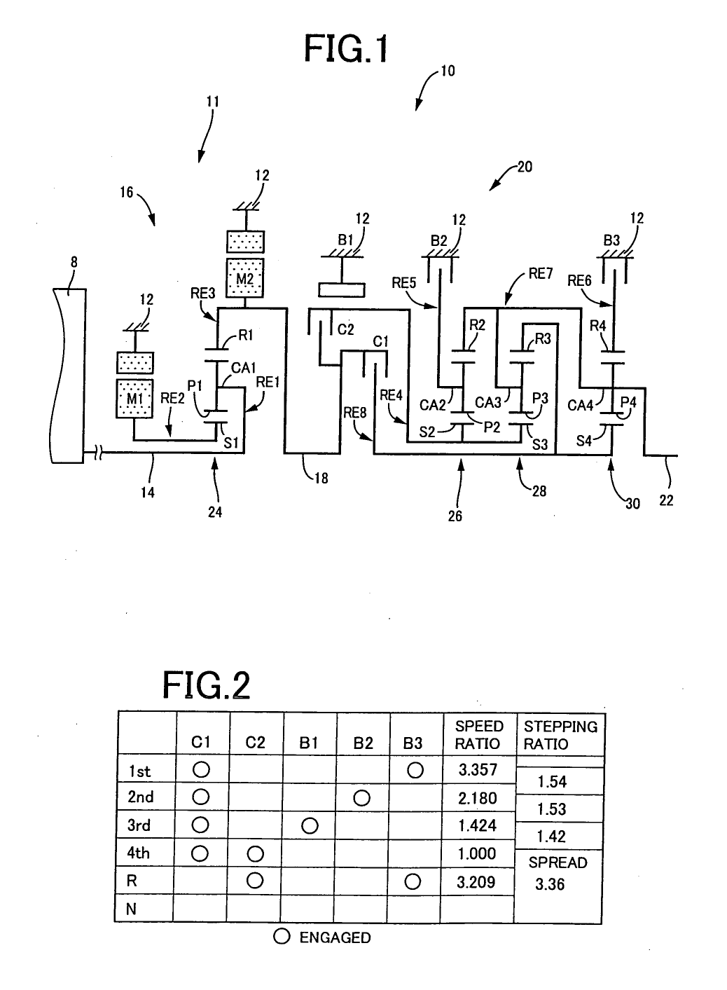

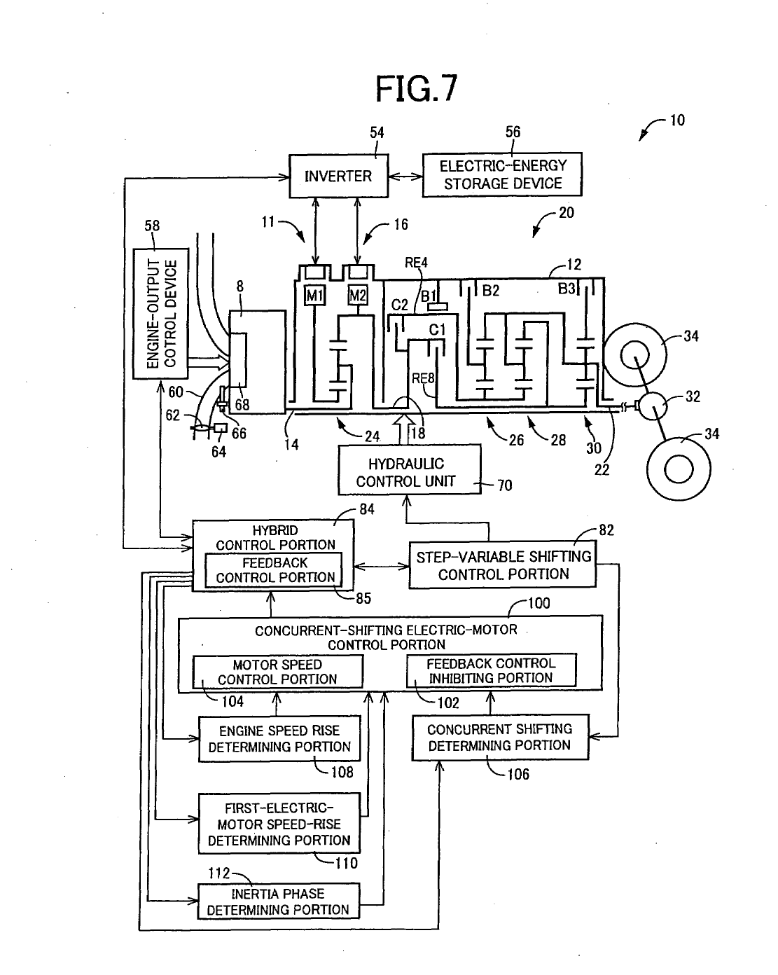

Referring first to the schematic view of FIG. 1, there is shown a transmission mechanism 10 constituting a part of a power transmitting system for a hybrid vehicle, which power transmitting system is controlled by a control apparatus constructed according to a first embodiment of this invention. As shown in FIG. 1, the transmission mechanism 10 includes: an input rotary member in the form of an input shaft 14; a continuously-variable transmission portion in the form of a differential portion 11 connected to the input shaft 14 either directly, or indirectly via a pulsation absorbing damper (vibration damping device) not shown; a power transmitting portion in the form of a hydraulic automatic transmission portion 20 disposed between the differential portion 11 and drive wheels 34 (shown in FIG. 7) of the hybrid vehicle, and connected in series via a power transmitting member 18 (power transmitting shaft) to the differential portion 11 and the drive wheels 34; and an output rotary member in the form of an output shaft 22 connected to the automatic transmission portion 20. The input shaft 12, differential portion 11, automatic transmission portion 20 and output shaft 22 are coaxially disposed on a common axis in a transmission casing 12 (hereinafter referred to simply as “casing 12”) functioning as a stationary member attached to a body of the vehicle, and are connected in series with each other. This transmission mechanism 10 is suitably used for a transverse FR vehicle (front-engine, rear-drive vehicle), and is disposed between a drive power source in the form of an internal combustion engine 8 and the pair of drive wheels 34, to transmit a vehicle drive force from the engine 8 to the pair of drive wheels 34 through a differential gear device 32 (final speed reduction gear) and a pair of drive axles, as shown in FIG. 7. The engine 8 may be a gasoline engine or diesel engine and functions as a vehicle drive power source directly connected to the input shaft 14 or indirectly via a pulsation absorbing damper. It will be understood that the engine 8 functions as a drive power source of the drive system, while the transmission mechanism 10 functions as the power transmitting system controlled by the control apparatus according to the principle of this invention.

In the present transmission mechanism 10 constructed as described above, the engine 8 and the differential portion 11 are directly connected to each other. This direct connection means that the engine 8 and the transmission portion 11 are connected to each other, without a fluid-operated power transmitting device such as a torque converter or a fluid coupling being disposed therebetween, but may be connected to each other through the pulsation absorbing damper as described above. It is noted that a lower half of the transmission mechanism 10, which is constructed symmetrically with respect to its axis, is omitted in FIG. 1. his is also true to the other embodiments of the invention described below.

The differential portion 11 is provided with: a first electric motor M1; a power distributing mechanism 16 functioning as a differential mechanism operable to mechanically distribute an output of the engine 8 received by the input shaft 14, to the first electric motor M1 and the power transmitting member 18; and a second electric motor M2 which is operatively connected to and rotated with the power transmitting member 18. Each of the first and second electric motors M1 and M2 used in the present embodiment is a so-called motor/generator having a function of an electric motor and a function of an electric generator. However, the first electric motor M1 should function at least as an electric generator operable to generate an electric energy and a reaction force, while the second electric motor M2 should function at least as a drive power source operable to produce a vehicle drive force. It will be understood that the differential portion 11 functions as an electrically controlled differential portion.

The power distributing mechanism 16 includes, as a major component, a first planetary gear set 24 of a single pinion type having a gear ratio ρ1 of about 0.418, for example. The first planetary gear set 24 has rotary elements consisting of: a first sun gear S1, a first planetary gear P1; a first carrier CA1 supporting the first planetary gear P1 such that the first planetary gear P1 is rotatable about its axis and about the axis of the first sun gear S1; and a first ring gear R1 meshing with the first sun gear S1 through the first planetary gear P1. Where the numbers of teeth of the first sun gear S1 and the first ring gear R1 are represented by ZS1 and ZR1, respectively, the above-indicated gear ratio ρ1 is represented by ZS1/ZR1.

In the power distributing mechanism 16, the first carrier CA1 is connected to the input shaft 14, that is, to the engine 8, and the first sun gear S1 is connected to the first electric motor M1, while the first ring gear R1 is connected to the power transmitting member 18. The power distributing mechanism 16 constructed as described above is operated in a differential state in which three elements of the first planetary gear set 24 consisting of the first sun gear S1, first carrier CA1 and first ring gear R1 are rotatable relative to each other, so as to perform a differential function. In the differential state, the output of the engine 8 is distributed to the first electric motor M1 and the power transmitting member 18, whereby a portion of the output of the engine 8 is used to drive the first electric motor M1 to generate an electric energy which is stored or used to drive the second electric motor M2. Namely, the differential portion 11 (power distributing mechanism 16) functions as an electric differential device, which is operable in a continuously-variable shifting state (electrically established CVT state) in which the rotating speed of the power transmitting member 18 is continuously variable, irrespective of the rotating speed of the engine 8, namely, placed in the differential state in which a speed ratio γ0 (rotating speed N_{IN} of the input shaft 14/rotating speed N₁₈ of the power transmitting member 18) of the differential portion 11 is continuously changed from a minimum value γ0min to a maximum value γ0max, that is, in the continuously-variable shifting state in which the differential portion 11 functions as an electrically controlled continuously-variable transmission the speed ratio γ0 of which is continuously variable from the minimum value γ0min to the maximum value γ0max. Thus, the differential portion 11 functions as a continuously-variable transmission mechanism wherein a differential state between the rotating speed of the input shaft 14 and the rotating speed of the power transmitting member 18 functioning as the output shaft of the differential portion 11 is controlled by controlling the operating states of the first electric motor M1, second electric motor M2 and engine 8 that are operatively connected to the power distributing mechanism 16. It will be understood that the power distributing mechanism 16 functions as a differential mechanism, while the power transmitting member 18 functions as the output shaft of the differential mechanism.

The automatic transmission portion 20 is a step-variable automatic transmission which constitutes a part of a power transmitting path between the differential portion 11 and the drive wheels 34. The automatic transmission portion 20 includes a single-pinion type second planetary gear set 26, a single-pinion type third planetary gear set 28 and a single-pinion type fourth planetary gear set 30. Thus, the automatic transmission portion 20 is a multiple-step transmission of a planetary gear type. The second planetary gear set 26 has: a second sun gear S2; a second planetary gear P2; a second carrier CA2 supporting the second planetary gear P2 such that the second planetary gear P2 is rotatable about its axis and about the axis of the second sun gear S2; and a second ring gear R2 meshing with the second sun gear S2 through the second planetary gear P2. For example, the second planetary gear set 26 has a gear ratio ρ2 of about 0.562. The third planetary gear set 28 has: a third sun gear S3; a third planetary gear P3; a third carrier CA3 supporting the third planetary gear P3 such that the third planetary gear P3 is rotatable about its axis and about the axis of the third sun gear S3; and a third ring gear R3 meshing with the third sun gear S3 through the third planetary gear P3. For example, the third planetary gear set 28 has a gear ratio ρ3 of about 0.425. The fourth planetary gear set 30 has: a fourth sun gear S4; a fourth planetary gear P4; a fourth carrier CA4 supporting the fourth planetary gear P4 such that the fourth planetary gear P4 is rotatable about its axis and about the axis of the fourth sun gear S4; and a fourth ring gear R4 meshing with the fourth sun gear S4 through the fourth planetary gear P4. For example, the fourth planetary gear set 30 has a gear ratio p4 of about 0.421. Where the numbers of teeth of the second sun gear S2, second ring gear R2, third sun gear S3, third ring gear R3, fourth sun gear S4 and fourth ring gear R4 are represented by ZS2, ZR2, ZS3, ZR3, ZS4 and ZR4, respectively, the above-indicated gear ratios ρ2, ρ3 and ρ4 are represented by ZS2/ZR2, ZS3/ZR3, and ZS4/ZR4, respectively. It will be understood that the automatic transmission portion 20 functions as a step-variable transmission portion. It will be understood that the automatic transmission portion 20 functions as a transmission portion which constitutes a part of the power transmitting path between the differential portion 11 and the drive wheels 34.

In the automatic transmission portion 20, the second sun gear S2 and the third sun gear S3 are integrally fixed to each other as a unit, selectively connected to the power transmitting member 18 through a second clutch C2, and selectively fixed to the casing 12 through a first brake B1. The second carrier CA2 is selectively fixed to the casing 12 through a second brake B2, and the fourth ring gear R4 is selectively fixed to the casing 12 through a third brake B3. The second ring gear R2, third carrier CA3 and fourth carrier CA4 are integrally fixed to each other and fixed to the output shaft 22. The third ring gear R3 and the fourth sun gear S4 are integrally fixed to each other and selectively connected to the power transmitting member 18 through a first clutch C1.

Thus, the automatic transmission portion 20 and the differential portion 11 (power transmitting member 18) are selectively connected to each other through one of the first and second clutches C1, C2, which are provided to shift the automatic transmission portion 20. In other words, the first and second clutches C1, C2 function as coupling devices operable to switch a power transmitting path between the power distributing member 18 and the automatic transmission portion 20 (power transmitting path between the differential portion 11 or power transmitting member 18 and the drive wheels 34), to a selected one of a power transmitting state in which a vehicle drive force can be transmitted through the power transmitting path, and a power cut-off state (non-power-transmitting state) in which the vehicle drive force cannot be transmitted through the power transmitting path. When at least one of the first and second clutches C1 and C2 is placed in the engaged state, the power transmitting path is placed in the power transmitting state. When both of the first and second clutches C1, C2 are placed in the released state, the power transmitting path is placed in the power cut-off state. It will be understood that the first and second clutches C1, C2 function as a switching portion operable to switch the power transmitting path between the differential portion 11 and the drive wheels 34, between the power transmitting state and the power cut-off state.

The automatic transmission portion 20 is operable to perform a so-called “clutch-to-clutch” shifting action to establish a selected one of its operating positions (gear positions) by an engaging action of one of coupling devices and a releasing action of another coupling device. The above-indicated operating positions have respective speed ratios γ (rotating speed N₁₈ of the power transmitting member 18/rotating speed N_{OUT} of the output shaft 22) which change as geometric series. As indicated in the table of FIG. 2, the first gear position having the highest speed ratio γ1 of about 3.357, for example, is established by engaging actions of the first clutch C1 and third brake B3, and the second gear position having the speed ratio γ2 of about 2.180, for example, which is lower than the speed ratio γ1, is established by engaging actions of the first clutch C1 and second brake B2. Further, the third gear position having the speed ratio γ3 of about 1.424, for example, which is lower than the speed ratio γ2, is established by engaging actions of the first clutch C1 and first brake B1, and the fourth gear position having the speed ratio γ4 of about 1.000, for example, which is lower than the speed ratio γ3, is established by engaging actions of the first clutch C1 and second clutch C2. The reverse gear position having the speed ratio γR of about 3.209, for example, which is intermediate between the speed ratios γ1 and γ2, is established by engaging actions of the second clutch C2 and the third brake B3, and the neutral position N is established when all of the first clutch C1, second clutch C2, first brake B1, second brake B2 and third brake B3 are placed in the released state.

The above-described first clutch C1, second clutch C2, first brake B1, second brake B2 and third brake B3 (hereinafter collectively referred to as clutches C and brakes B, unless otherwise specified) are hydraulically operated frictional coupling devices used in a conventional vehicular automatic transmission. Each of these frictional coupling devices is constituted by a wet-type multiple-disc clutch including a plurality of friction plates which are forced against each other by a hydraulic actuator, or a band brake including a rotary drum and one band or two bands which is/are wound on the outer circumferential surface of the rotary drum and tightened at one end by a hydraulic actuator. Each of the clutches C1, C2 and brakes B1-B3 is selectively engaged for connecting two members between which each clutch or brake is interposed.

In the transmission mechanism 10 constructed as described above, the differential portion 11 functioning as the continuously-variable transmission and the automatic transmission portion 20 cooperate with each other to constitute a continuously-variable transmission the speed ratio of which is continuously variable. While the differential portion 11 is controlled to hold its speed ratio constant, the differential portion 11 and the automatic transmission portion 20 cooperate to constitute a step-variable transmission the speed ratio of which is variable in steps.

When the differential portion 11 functions as the continuously-variable transmission while the automatic transmission portion 20 connected in series to the differential portion 11 functions as the step-variable transmission, the speed of the rotary motion transmitted to the automatic transmission portion 20 placed in a selected one of the gear positions M (hereinafter referred to as “input speed of the automatic transmission portion 20”), namely, the rotating speed of the power transmitting member 18 (hereinafter referred to as “transmitting-member speed N₁₈”) is continuously changed, so that the speed ratio of the hybrid vehicle drive system when the automatic transmission portion 20 is placed in the selected gear position M is continuously variable over a predetermined range. Accordingly, an overall speed ratio γT of the transmission mechanism 10 (rotating speed N_{IN} of the input shaft 14/rotating speed N_{OUT} of the output shaft 22) is continuously variable. Thus, the transmission mechanism 10 as a whole is operable as a continuously-variable transmission. The overall speed ratio γT is determined by the speed ratio γ0 of the differential portion 11 and the speed ratio γ of the automatic transmission portion 20.

For example, the transmitting-member speed N₁₈ is continuously variable over the predetermined range when the differential portion 11 functions as the continuously-variable transmission while the automatic transmission portion 20 is placed in a selected one of the first through fourth gear positions and reverse gear position as indicated in the table of FIG. 2. Accordingly, the overall speed ratio γT of the transmission mechanism 10 is continuously variable across the adjacent gear positions.

When the speed ratio γ0 of the differential portion 11 is held constant while the clutches C and brakes B are selectively engaged to establish the selected one of the first through fourth gear positions and the reverse gear position, the overall speed ratio γT of the transmission mechanism 10 is variable in step as geometric series. Thus, the transmission mechanism 10 is operable like a step-variable transmission.

When the speed ratio γ0 of the differential portion 11 is held constant at 1, for example, the overall speed ratio γT of the transmission mechanism 10 changes as the automatic transmission portion 20 is shifted from one of the first through fourth gear positions and reverse gear position to another, as indicated in the table of FIG. 2. When the speed ratio γ0 of the differential portion 11 is held constant at a value smaller than 1, for example, at about 0.7, while the automatic transmission portion 20 is placed in the fourth gear position, the overall speed ratio γT of the transmission mechanism 10 is controlled to be about 0.7.

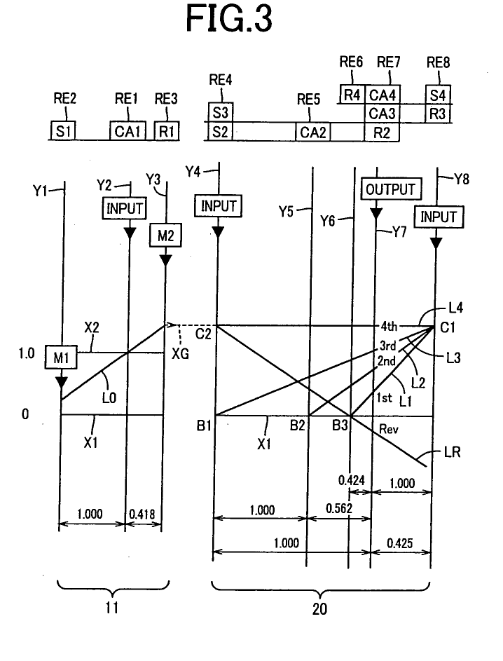

The collinear chart of FIG. 3 indicates, by straight lines, a relationship among the rotating speeds of the rotary elements in each of the gear positions of the transmission mechanism 10, which is constituted by the differential portion 11 and the automatic transmission portion 20. The different gear positions correspond to respective different states of connection of the rotary elements. The collinear chart of FIG. 3 is a rectangular two-dimensional coordinate system in which the gear ratios ρ of the planetary gear sets 24, 26, 28, 30 are taken along the horizontal axis, while the relative rotating speeds of the rotary elements are taken along the vertical axis. The horizontal line X1 indicates the rotating speed of 0, while the horizontal line X2 indicates the rotating speed of 1.0, that is, an operating speed N_{E} of the engine 8 connected to the input shaft 14. The horizontal line XG indicates the rotating speed of the power transmitting member 18.

Three vertical lines Y1, Y2 and Y3 corresponding to the power distributing mechanism 16 of the differential portion 11 respectively represent the relative rotating speeds of a second rotary element (second element) RE2 in the form of the first sun gear S1, a first rotary element (first element) RE1 in the form of the first carrier CA1, and a third rotary element (third element) RE3 in the form of the first ring gear R1. The distances between the adjacent ones of the vertical lines Y1, Y2 and Y3 are determined by the gear ratio ρ1 of the first planetary gear set 24. That is, the distance between the vertical lines Y1 and Y2 corresponds to “1”, while the distance between the vertical lines Y2 and Y3 corresponds to the gear ratio ρ1. Further, five vertical lines Y4, Y5, Y6, Y7 and Y8 corresponding to the transmission portion 20 respectively represent the relative rotating speeds of a fourth rotary element (fourth element) RE4 in the form of the second and third sun gears S2, S3 integrally fixed to each other, a fifth rotary element (fifth element) RE5 in the form of the second carrier CA2, a sixth rotary element (sixth element) RE6 in the form of the fourth ring gear R4, a seventh rotary element (seventh element) RE7 in the form of the second ring gear R2 and third and fourth carriers CA3, CA4 that are integrally fixed to each other, and an eighth rotary element (eighth element) RE8 in the form of the third ring gear R3 and fourth sun gear S4 integrally fixed to each other. The distances between the adjacent ones of the vertical lines are determined by the gear ratios ρ2, ρ3 and ρ4 of the second, third and fourth planetary gear sets 26, 28, 30. In the relationship among the vertical lines of the collinear chart, the distances between the sun gear and carrier of each planetary gear set corresponds to “1”, while the distances between the carrier and ring gear of each planetary gear set corresponds to the gear ratio ρ. In the differential portion 11, the distance between the vertical lines Y1 and Y2 corresponds to “1”, while the distance between the vertical lines Y2 and Y3 corresponds to the gear ratio ρ. In the automatic transmission portion 20, the distance between the sun gear and carrier of each of the second, third and fourth planetary gear sets 26, 28, 30 corresponds to “1”, while the distance between the carrier and ring gear of each planetary gear set 26, 28, 30 corresponds to the gear ratio ρ. Referring to the collinear chart of FIG. 3, the power distributing mechanism 16 (differential portion 11) of the transmission mechanism 10 is arranged such that the first rotary element RE1 (first carrier CA1) of the first planetary gear set 24 is integrally fixed to the input shaft 14 (engine 8), and the second rotary element RE2 is fixed to the first electric motor M1, while the third rotary element RE3 (first ring gear R1) is fixed to the power transmitting member 18 and the second electric motor M2, so that a rotary motion of the input shaft 14 is transmitted (input) to the automatic transmission portion 20 through the power transmitting member 18. A relationship between the rotating speeds of the first sun gear S1 and the first ring gear R1 is represented by an inclined straight line L0 which passes a point of intersection between the lines Y2 and X2.

In the differential state of the differential portion 11 in which the first through third rotary elements RE1-RE3 are rotatable relative to each other, for example, the rotating speed of the first sun gear S1, that is, the rotating speed of the first electric motor M1, which is represented by a point of intersection between the straight line L0 and the vertical line Y1, is raised or lowered by controlling the engine speed N_{E}, S0 that the rotating speed of the first carrier CA1 represented by a point of intersection between the straight line L0 and the vertical line Y2, if the rotating speed of the first ring gear R1 represented by a point of intersection between the straight line L0 and the vertical line Y3 is substantially held constant.

When the rotating speed of the first electric motor M1 is controlled such that the speed ratio γ0 of the differential portion 11 is held at 1, so that the rotating speed of the first sun gear S1 is made equal to the engine speed N_{E}, the straight line L0 is aligned with the horizontal line X2, so that the first ring gear R1, that is, the power transmitting member 18 is rotated at the engine speed N_{E}. When the rotating speed of the first electric motor M1 is controlled such that the speed ratio γ0 of the differential portion 11 is held at a value lower than 1, for example at 0.7, on the other hand, so that the rotating speed of the first sun gear S1 is zeroed, the power transmitting member 18 is rotated at a speed N₁₈ higher than the engine speed N_{E}.

In the automatic transmission portion 20, the fourth rotary element RE4 is selectively connected to the power transmitting member 18 through the second clutch C2, and selectively fixed to the casing 12 through the first brake B1, and the fifth rotary element RE5 is selectively fixed to the casing 12 through the second brake B2, while the sixth rotary element RE6 is selectively fixed to the casing 12 through the third brake B3. The seventh rotary element RE7 is fixed to the output shaft 22, while the eighth rotary element RE8 is selectively connected to the power transmitting member 18 through the first clutch C1.

The automatic transmission portion 20 is placed in the first gear position when the first clutch C1 and the third brake B3 are engaged in the state of the differential portion 11 in which a rotary motion of the differential portion 11 at a speed equal to the engine speed NE is input to the eighth rotary element RE8 of the automatic transmission portion 20. The rotating speed of the output shaft 22 in the first gear position is represented by a point of intersection between the vertical line Y7 indicative of the rotating speed of the seventh rotary element RE7 fixed to the output shaft 22 and an inclined straight line L1 which passes a point of intersection between the vertical line Y8 indicative of the rotating speed of the eighth rotary element RE8 and the horizontal line X2, and a point of intersection between the vertical line Y6 indicative of the rotating speed of the sixth rotary element RE6 and the horizontal line X1, as indicated in FIG. 3. Similarly, the rotating speed of the output shaft 22 in the second gear position established by the engaging actions of the first clutch C1 and second brake B2 is represented by a point of intersection between an inclined straight line L2 determined by those engaging actions and the vertical line Y7 indicative of the rotating speed of the seventh rotary element RE7 fixed to the output shaft 22. The rotating speed of the output shaft 22 in the third gear position established by the engaging actions of the first clutch C1 and first brake B1 is represented by a point of intersection between an inclined straight line L3 determined by those engaging actions and the vertical line Y7 indicative of the rotating speed of the seventh rotary element RE7 fixed to the output shaft 22. The rotating speed of the output shaft 22 in the fourth gear position established by the engaging actions of the first clutch C1 and second clutch C2 is represented by a point of intersection between a horizontal line L4 determined by those engaging actions and the vertical line Y7 indicative of the rotating speed of the seventh rotary element RE7 fixed to the output shaft 22.

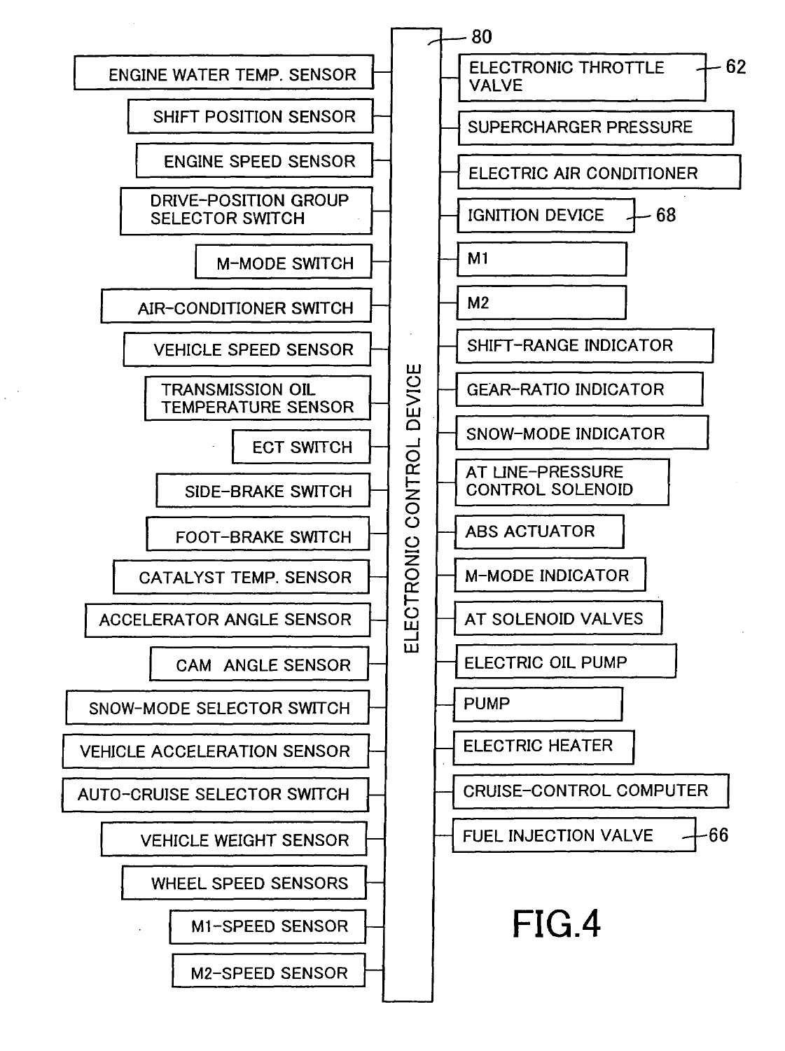

FIG. 4 illustrates signals received by an electronic control device 80 provided to control the transmission mechanism 10, and signals generated by the electronic control device 80. This electronic control device 80 includes a so-called microcomputer incorporating a CPU, a ROM, a RAM and an input/output interface, and is arranged to process the signals according to programs stored in the ROM while utilizing a temporary data storage function of the ROM, to implement hybrid drive controls of the engine 8 and first and second electric motors M1 and M2, and drive controls such as shifting controls of the automatic transmission portion 20.

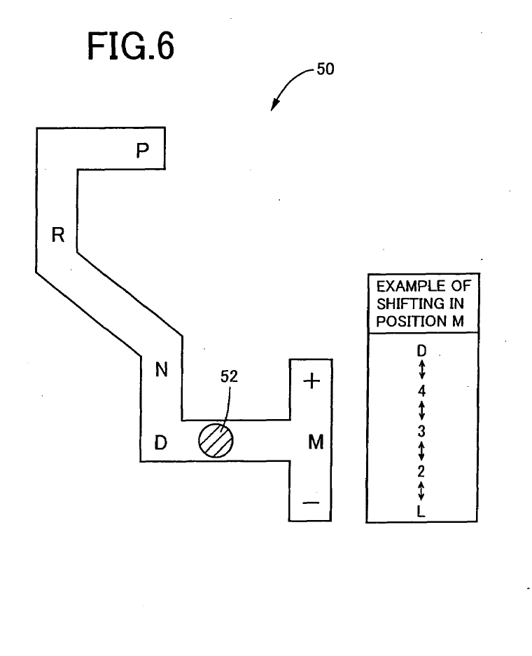

The electronic control device 80 is arranged to receive from various sensors and switches shown in FIG. 4, various signals such as: a signal indicative of a temperature TEMP_{w} of cooling water of the engine 8; a signal indicative of a selected one of operating positions P_{SH} of a manually operable shifting member in the form of a shift lever 52 (shown in FIG. 6); a signal indicative of the number of operations of the shift lever 52 from a manual forward-drive shifting position M (described below); a signal indicative of the operating speed N_{E} of the engine 8; a signal indicative of a value indicating a selected group of forward-drive positions of the transmission mechanism 10; a signal indicative of an M mode (manual shifting mode); a signal indicative of an operated state of an air conditioner; a signal indicative of a vehicle speed V corresponding to the rotating speed N_{OUT} of the output shaft 22 (hereinafter referred to as “output shaft speed”); a signal indicative of a temperature T_{OIL} of a working fluid or oil of the automatic transmission portion 20; a signal indicative of an operated state of a side brake; a signal indicative of an operated state of a foot brake pedal; a signal indicative of a temperature of a catalyst; a signal indicative of a required amount of an output of the vehicle in the form of an amount of operation (an angle of operation) A_{CC} of an accelerator pedal; a signal indicative of an angle of a cam; a signal indicative of the selection of a snow drive mode; a signal indicative of a longitudinal acceleration value G of the vehicle; a signal indicative of the selection of an auto-cruising drive mode; a signal indicative of a weight of the vehicle; signals indicative of speeds of the wheels of the vehicle; a signal indicative of a rotating speed N_{M1} of the first electric motor M1 (hereinafter referred to as “first electric motor speed N_{M1}, where appropriate); a signal indicative of a rotating speed N_{M2} of the second electric motor M2 (hereinafter referred to as “second electric motor speed N_{M2}, where appropriate); and a signal indicative of an amount of electric energy SOC stored in an electric-energy storage device 60 (shown in FIG. 7).

The electronic control device 80 is further arranged to generate various signals such as: control signals to be applied to an engine output control device 58 (shown in FIG. 7) to control the output of the engine 8, such as a drive signal to drive a throttle actuator 64 for controlling an angle of opening θ_{TH} of an electronic throttle valve 62 disposed in an intake pipe 60 of the engine 8, a signal to control an amount of injection of a fuel by a fuel injecting device 66 into the intake pipe 60 or cylinders of the engine 8, a signal to be applied to an ignition device 68 to control the ignition timing of the engine 8, and a signal to adjust a supercharger pressure of the engine 8; a signal to operate the electric air conditioner; signals to operate the first and second electric motors M1 and M2; a signal to operate a shift-range indicator for indicating the selected operating or shift position of the shift lever 52; a signal to operate a gear-ratio indicator for indicating the gear ratio; a signal to operate a snow-mode indicator for indicating the selection of the snow drive mode; a signal to operate an ABS actuator for anti-lock braking of the wheels; a signal to operate an M-mode indicator for indicating the selection of the M-mode; signals to operate solenoid-operated valves in the form of linear solenoid valves incorporated in a hydraulic control unit 70 (shown in FIG. 7) provided to control the hydraulic actuators of the hydraulically operated frictional coupling devices of the differential portion 11 and automatic transmission portion 20; a signal to operate a regulator valve incorporated in the hydraulic control unit 70, to regulate a line pressure PL; a signal to control an electrically operated oil pump which is hydraulic pressure source for generating a hydraulic pressure that is regulated to the line pressure PL; and a signal to drive an electric heater; a signal to be applied to a cruise-control computer.

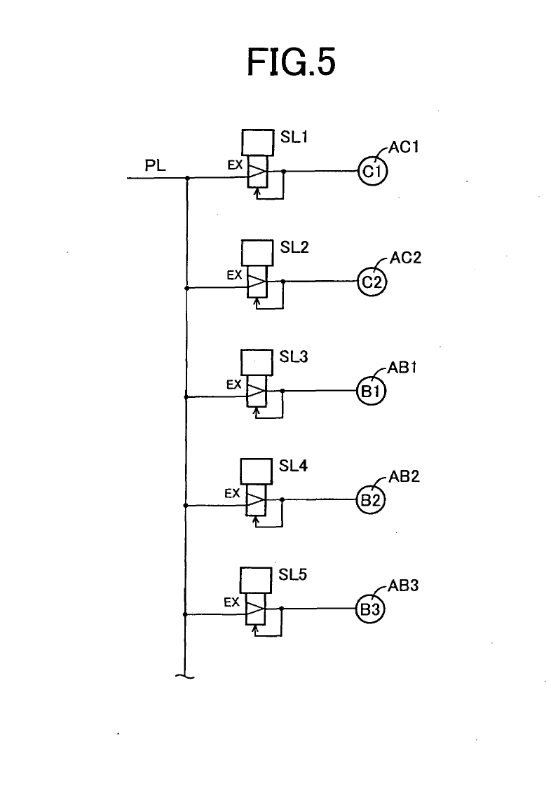

FIG. 5 shows a hydraulic circuit of the hydraulic control unit 70 arranged to control linear solenoid valves SL1-SL5 for controlling hydraulic actuators (hydraulic cylinders) AC1, AC2, AB1, AB2 and AB3 for actuating the clutches C1, C2 and brakes B1-B3.

As shown in FIG. 5, the hydraulic actuators AC1, AC2, AB1, AB2, AB3 are connected to the respective linear solenoid valves SL1-SL5, which are controlled according to control commands from the electronic control device 80, for adjusting the line pressure PL into respective engaging pressures PC1, PC2, PB1, PB2 and PB3 to be applied directly to the respective hydraulic actuators AC1, AC2, AB1, AB2, AB3. The line pressure PL is a pressure which is generated by the mechanical oil pump 40 driven by the engine 8 or the electric oil pump 76 provided in addition to the mechanical oil pump 40, and which is regulated by a relief-type pressure regulator valve according to a load of the engine 8 as represented by the operation amount A_{CC} of the accelerator pedal or the opening angle θ_{TH} of the electronic throttle valve 62, for example.

The linear solenoid valves SL1-SL5 have substantially the same construction, and are controlled independently of each other by the electronic control device 80, to adjust the hydraulic pressures of the hydraulic actuators AC1, AC2, AB1, AB2, AB3 independently of each other, for controlling the engaging pressures PC1, PC2, PB1, PB2, PB3, so that the appropriate two coupling devices (C1, C2, B1, B2, B3) are engaged to shift the automatic transmission portion 20 to the selected operating position or gear position. A shifting action of the automatic transmission portion 20 from one position to another is a so-called “clutch-to-clutch” shifting action involving an engaging action of the coupling devices (C, B) and a releasing action another of the coupling devices, which take place concurrently.

FIG. 6 shows an example of a manually operable shifting device in the form of a shifting device 50. The shifting device 50 includes the above-described shift lever 52, which is disposed laterally adjacent to an operator's seat of the vehicle, for example, and which is manually operated to select one of the plurality of operating positions P_{SH}.

The operating positions P_{SH} of the shift lever 52 consists of: a parking position P for placing the transmission mechanism 10 (namely, automatic transmission portion 20) in a neutral state in which a power transmitting path through the automatic transmission portion 20 is disconnected while at the same time the output shaft 22 is placed in the locked state; a reverse-drive position R for driving the vehicle in the rearward direction; a neutral position N for placing the transmission mechanism 10 in the neutral state; an automatic forward-drive shifting position D for establishing an automatic shifting mode; and the above-indicated manual forward-drive shifting position M for establishing a manual shifting mode. In the automatic shifting mode, the overall speed ratio γT is determined by the continuously variable speed ratio of the differential portion 11 and the speed ratio of the automatic transmission portion 20 which changes in steps as a result of an automatic shifting action of the automatic transmission portion 20 from one of the first through fourth gear positions to another. In the manual shifting mode, the number of the gear positions available is limited by disabling the automatic transmission portion 20 to be shifted to the relatively high gear position or positions.

As the shift lever 52 is operated to a selected one of the operating positions P_{SH}, the hydraulic control unit 70 is electrically operated to switch the hydraulic circuit to establish the rear-drive position R, neutral position N, and one of the forward-drive first through fourth gear positions, as indicated in the table of FIG. 2.

The above-indicated parking position P and the neutral position N are non-drive positions selected when the vehicle is not driven, while the above-indicated reverse-drive position R, and the automatic and manual forward-drive positions D, M are drive positions selected when the vehicle is driven. In the non-drive positions P, N, the power transmitting path in the automatic transmission portion 20 is in the power cut-off state established by releasing both of the clutches C1 and C2, as shown in the table of FIG. 2. In the drive positions R, D, M, the power transmitting path in the automatic transmission portion 20 is in the power transmitting state established by engaging at least one of the clutches C1 and C2, as also shown in the table of FIG. 2.

Described in detail, a manual operation of the shift lever 52 from the parking position P or neutral position N to the reverse-drive position R causes the second clutch C2 to be engaged for switching the power transmitting path in the automatic transmission portion 20 from the power-cut-off state to the power-transmitting state. A manual operation of the shift lever 52 from the neutral position N to the automatic forward-drive position D causes at least the first clutch C1 to be engaged for switching the power transmitting path in the automatic transmission portion 20 from the power-cut-off state to the power-transmitting state. A manual operation of the shift lever 52 from the rear-drive position R to the parking position P or neutral position N cause the second clutch C2 to be released for switching the power transmitting path in the automatic transmission portion 20 from the power-transmitting state to the power-cut-off state. A manual operation of the shift lever 52 from the automatic forward-drive position D to the neutral position N causes the first clutch C1 and the second clutch C2 to be released for switching the power transmitting path from the power-transmitting state to the power-cut-off state.

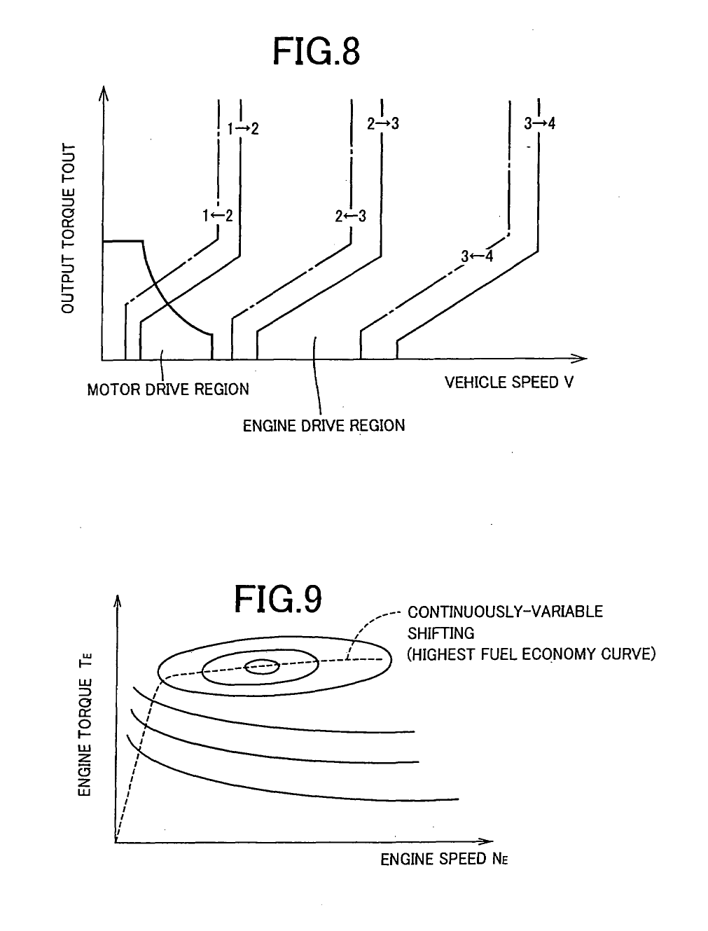

Referring to the functional block diagram of FIG. 7, the electronic control device 80 includes a step-variable shifting control portion 82, a hybrid control portion 84, a concurrent-shifting electric-motor control portion 100, a concurrent shifting determining portion 106, an engine speed rise determining portion 108, a first-electric-motor speed-rise determining portion 110 and an inertia phase determining portion 112. The step-variable shifting control portion 82 is configured to determine whether a shifting action of the automatic transmission portion 20 should take place, that is, to determine the gear position to which the automatic transmission portion 20 should be shifted. This determination is made on the basis of a condition of the vehicle represented by the actual vehicle running speed V and the actual output torque T_{OUT} of the automatic transmission portion 20, and according to a stored shifting boundary line map (shifting control map or relation) which represents shift-up boundary lines indicated by solid lines in FIG. 8 and shift-down boundary lines indicated by one-dot chain lines in FIG. 8.

The step-variable shifting control portion 82 generates a shifting command (hydraulic control command) to be applied to the hydraulic control unit 70, to engage and release the appropriate two hydraulically operated frictional coupling devices (C1, C2, B1, B2, B3), for establishing the determined gear position of the automatic transmission portion 20 according to the table of FIG. 2. Described in detail, the step-variable shifting control portion 82 commands the hydraulic control unit 70 to control the appropriate two linear solenoid valves SL incorporated in the hydraulic control unit 70, for activating the appropriate hydraulic actuators of the appropriate two frictional coupling devices (C, B) to concurrently engage one of the two frictional coupling devices and release the other frictional coupling device, to effect the clutch-to-clutch shifting action of the automatic transmission portion 20 to the determined gear position.

The hybrid control portion 84 controls the engine 8 to be operated with high efficiency, and controls the first and second electric motors M1, M2 so as to optimize a proportion of drive forces generated by the engine 8 and the second electric motor M2, and a reaction force generated by the first electric motor M1 during its operation as the electric generator, for thereby controlling the speed ratio γ0 of the differential portion 11 operating as the electric continuously-variable transmission. For instance, the hybrid control portion 84 calculates a target (required) vehicle output at the present running speed V of the vehicle, on the basis of the operation amount A_{CC} of the accelerator pedal 74 used as an operator's required vehicle output and the vehicle running speed V, and calculate a target total vehicle output on the basis of the calculated target vehicle output and a required amount of generation of an electric energy by the first electric motor M1. The hybrid control portion 84 calculates a target output of the engine 8 to obtain the calculated target total vehicle output, while taking account of a power transmission loss, a load acting on various devices of the vehicle, an assisting torque generated by the second electric motor M2, etc. The hybrid control portion 84 controls the speed N_{E} and torque T_{E} of the engine 8, so as to obtain the calculated target engine output, and the amount of generation of the electric energy by the first electric motor M1.

The hybrid control portion 84 is arranged to implement the hybrid control while taking account of the presently selected gear position of the automatic transmission portion 20, so as to improve the drivability of the vehicle and the fuel economy of the engine 8. In the hybrid control, the differential portion 11 is controlled to function as the electric continuously-variable transmission, for optimum coordination of the engine speed N_{E} for its efficient operation, and the rotating speed of the power transmitting member 18 determined by the vehicle speed V and the selected gear position of the transmission portion 20. That is, the hybrid control portion 82 determines a target value of the overall speed ratio γT of the transmission mechanism 10, so that the engine 8 is operated according to a stored highest-fuel-economy curve (fuel-economy map or relation) indicated by broken line in FIG. 9. The target value of the overall speed ratio γt of the transmission mechanism 10 permits the engine torque T_{E} and speed N_{E} to be controlled so that the engine 8 provides an output necessary for obtaining the target vehicle output (target total vehicle output or required vehicle drive force). The highest-fuel-economy curve is obtained by experimentation so as to satisfy both of the desired operating efficiency and the highest fuel economy of the engine 8, and is defined in a two-dimensional coordinate system defined by an axis of the engine speed N_{E} and an axis of the engine torque T_{E}. The hybrid control portion 82 controls the speed ratio γ0 of the differential portion 11, so as to obtain the target value of the overall speed ratio γT, so that the overall speed ratio γT can be controlled within a predetermined range.

In the hybrid control, the hybrid control portion 84 controls an inverter 54 such that the electric energy generated by the first electric motor M1 is supplied to an electric-energy storage device 56 and the second electric motor M2 through the inverter 54. That is, a major portion of the drive force produced by the engine 8 is mechanically transmitted to the power transmitting member 18, while the remaining portion of the drive force is consumed by the first electric motor M1 to convert this portion into the electric energy, which is supplied through the inverter 54 to the second electric motor M2, so that the second electric motor M2 is operated with the supplied electric energy, to produce a mechanical energy to be transmitted to the power transmitting member 18. Thus, the drive system is provided with an electric path through which an electric energy generated by conversion of a portion of a drive force of the engine 8 is converted into a mechanical energy.

The hybrid control portion 84 is further arranged to hold the engine speed N_{E} substantially constant or at a desired value, by controlling the first electric motor speed N_{M1} and/or the second electric motor speed N_{M2} owing to the electric CVT function of the differential portion 11, irrespective of whether the vehicle is stationary or running. In other words, the hybrid control portion 84 is capable of controlling the first electric motor speed N_{M1} as desired while holding the engine speed N_{E} substantially constant or at a desired value. For example, the hybrid control portion 84 raises the engine speed N_{E} by raising the first electric motor speed N_{M1} during running of the vehicle while the second electric motor speed N_{M2} determined by the vehicle running speed V (rotating speed of the drive wheels 34) is held substantially constant.

To raise the engine speed N_{E} during running of the vehicle, for example, the hybrid control portion 84 raises the first electric motor speed N_{M1} while the second electric motor speed N_{M2} determined by the vehicle speed V (rotating speed of the drive wheels 34) is held substantially constant, as is apparent from the collinear chart of FIG. 3. To hold the engine speed N_{E} substantially constant during a shifting action of the automatic transmission portion 20, the hybrid control portion 84 changes the first electric motor speed N_{M1} in a direction opposite to a direction of change of the second electric motor speed N_{M2} due to the shifting action of the automatic transmission portion 20.

The hybrid control portion 84 includes engine output control means functioning to command the engine-output control device 58 for controlling the engine 8, so as to provide a required output, by controlling the throttle actuator 64 to open and close the electronic throttle valve 62, and controlling an amount and time of fuel injection by the fuel injecting device 66 into the engine 8, and/or the timing of ignition of the igniter by the ignition device 68, alone or in combination.

For instance, the hybrid control portion 84 is basically arranged to control the throttle actuator 64 on the basis of the operation amount A_{CC} of the accelerator pedal and according to a predetermined stored relationship (not shown) between the operation amount A_{CC} and the opening angle θ_{TH} of the electronic throttle valve 62 such that the opening angle θ_{TH} increases with an increase of the operation amount A_{CC}. The engine output control device 58 controls the throttle actuator 64 to open and close the electronic throttle valve 62, controls the fuel injecting device 66 to control the fuel injection, and controls the ignition device 68 to control the ignition timing of the igniter, for thereby controlling the torque of the engine 8, according to the commands received from the hybrid control portion 84.

The hybrid control portion 84 is capable of establishing a motor-drive mode to drive the vehicle by the electric motor, by utilizing the electric CVT function (differential function) of the differential portion 11, irrespective of whether the engine 8 is in the non-operated state or in the idling state. For example, the hybrid control portion 84 establishes the motor-drive mode, when the operating efficiency of the engine 8 is relatively low, or when the vehicle speed V is comparatively low or when the vehicle is running in a low-load state. For reducing a dragging of the engine 8 in its non-operated state and improving the fuel economy in the motor-drive mode, the hybrid control portion 84 is configured to hold the engine speed N_{E} at zero or substantially zero as needed, owing to the electric CVT function (differential function) of the differential portion 11, that is, by controlling the differential portion 11 to perform its electric CVT function, so that the first electric motor speed N_{M1} is controlled to be in a non-load state, so as to be freely rotated to have a negative speed N_{M1}.

The hybrid control portion 84 is further capable of performing a so-called “drive-force assisting” operation (torque assisting operation) to assist the engine 8, even in the engine-drive region of the vehicle condition, by supplying an electric energy from the first electric motor M1 or the electric-energy storage device 60 to the second electric motor M2 through the above-described electric path, so that the second electric motor M2 is operated to transmit a drive torque to the drive wheels 34.

The hybrid control portion 84 is further configured to place the first electric motor M1 in a non-load state in which the first electric motor M1 is freely rotated, so that the differential portion 11 is placed in a state similar to the power cut-off state in which power cannot be transmitted through the power transmitting path within the differential portion 11, and no output can be generated from the differential portion 11. Namely, the hybrid control portion 84 is arranged to place the first electric motor M1 in the non-load state, for thereby placing the differential portion 11 in a neutral state in which the power transmitting path is electrically cut off.

The hybrid control portion 84 functions as regeneration control means for operating the second electric motor M2 as the electric generator with a kinetic energy of the running vehicle, that is, with a drive force transmitted from the drive wheels 34 toward the engine 8, during coasting of the vehicle with the accelerator pedal 74 placed in the non-operated position, or during brake application to the vehicle with hydraulically operated wheel brakes 86 for the drive wheels 34, which are shown in FIG. 7. An electric energy generated by the second electric motor M2 is stored in the electric-energy storage device 56 through the inverter 54, for improving the fuel economy of the vehicle. The amount of electric energy to be generated by the second electric motor M2 is determined on the basis of the electric energy amount SOC stored in the electric-energy storage device 56, and a desired proportion of a regenerative braking force produced by the second electric motor. M2 operated as the electric generator, with respect to a total braking force which corresponds to the operating amount of a brake pedal and which consists of the regenerative braking force and a hydraulic braking force produced by the hydraulically operated wheel brakes 86.

The hybrid control portion 84 includes a feedback control portion 85 configured to control the operating speed N_{M1} of the first electric motor M1 according to the operating speed N_{M2} of the second electric motor M2, during a shifting action of the electrically controlled differential portion 11.

Where a shift-down action of the differential portion 11 and a shift-down action of the automatic transmission portion 20 take place concurrently, a direction of change of the operating speed N_{M1} of the first electric motor M1 due to the shift-down action of the differential portion 11 and a direction of change of the operating speed N_{M1} in an inertia phase of the shift-down action of the automatic transmission portion 20 are opposite to each other, so that the first electric motor M1 suffers from an unnecessary change of its speed N_{M1}, whereby an input torque of the automatic transmission portion 20 may vary, giving rise to a considerable shifting shock of the automatic transmission portion 20. In view of this drawback, the concurrent-shifting electric-motor control portion 100 (which will be described in detail) is provided to reduce the above-indicated unnecessary change of the operating speed N_{M1} of the first electric motor M1 upon concurrent shifting actions of the differential portion 11 and automatic transmission portion 20, for thereby reducing the shifting shock of the automatic transmission portion 20.

The concurrent-shifting electric-motor control portion 100 includes a feedback control inhibiting portion 102 and a motor speed control portion 104. The feedback inhibiting portion 102 is configured to inhibit the feedback control of the first electric motor M1 according to the operating speed N_{M2} of the second electric motor M2 upon concurrent shift-down actions of the differential portion 11 and automatic transmission portion 20, that is, where these shift-down actions take place concurrently or overlap each other.

The feedback control inhibiting portion 102 is operated when an affirmative determination is obtained by the concurrent shifting determining portion 106. The concurrent shifting determining portion 106 is configured to determine whether a shifting action of the differential portion 11 and a shifting action of the automatic transmission portion 20 take place concurrently. A determination as to whether a shift-down action of the differential portion 11 takes place is made by determining whether the operating speed N_{E} of the engine 8 is raised, that is, whether an operating point of the engine 8 changes. On the other hand, a determination as to whether a shift-down action of the automatic transmission portion 20 takes place is made by determining whether a point indicative of a running condition of the vehicle moves across any shift-down boundary line represented by the shifting boundary line map indicated in FIG. 8 by way of example. Where an affirmative determination that the shift-down action of the differential portion 11 takes place and an affirmative determination that the shift-down action of the automatic transmission portion 20 are obtained concurrently, the affirmative determination is obtained by the concurrent shifting determining portion 106, and the feedback control inhibiting portion 102 is operated. In this respect, it is noted that the above-indicated concurrent two shifting actions cause a movement of the operating point of the engine 8, so that the concurrent shifting determining portion 106 is considered to be configured to determine whether shifting actions of the differential portion 11 and automatic transmission portion 20 that cause a movement of the operating point of the engine 8 take place.

The motor speed control portion 104 of the concurrent-shifting electric-motor control portion 100 is configured to control the operating speed N_{M1} of the first electric motor M1 so as to reduce an amount of change of the operating speed N_{M1} during a shifting action of the automatic transmission portion 20. Described in detail, the motor speed control portion 104 controls the first electric motor M1 such that an actual amount of change of the operating speed N_{M1} during the shifting action coincides with a target value which is an estimated difference of the operating speed N_{M1} upon completion of the shifting action from that upon initiation of the shifting action. The estimated speed difference of the first electric motor M1 is obtained on the basis of estimated operating speeds N_{M2} of the second electric motor M2 and estimated operating speeds N_{E} of the engine 8 upon completion and initiation of the shifting action of the automatic transmission portion 20. The motor speed control portion 104 controls the operating speed N_{M1} of the first electric motor M1, on the basis of results of determinations made by the above-indicated engine speed rise determining portion 108, first-electric-motor speed-rise determining portion 110 and inertia phase determining portion 112.

The engine speed rise determining portion 108 is configured to determine whether an estimated engine speed N_{E2} upon completion or immediately after completion of the shifting action of the automatic transmission portion 20 is raised with respect to an estimated engine speed N_{E1} upon initiation or immediately before initiation of the shifting action. The estimated engine speed N_{E2} is the engine speed NE upon completion of the shifting action of the differential portion 11. For example, the estimated engine speed_{NE2} is obtained on the basis of the highest-fuel-economy curve indicated in FIG. 9, such that a target output of the engine 8 is obtained at the estimated engine speed N_{E2}. The target output of the engine 8 is calculated on the basis of the operating amount A_{CC} of the accelerator pedal and the vehicle speed V during the shifting action of the automatic transmission portion 20. The affirmative determination is obtained by the engine speed rise determining portion 108 when the estimated engine speed N_{E2} upon completion of the shifting action is raised with respect to the estimated engine speed N_{E1} upon or immediately before initiation of the shifting action.

The first-electric-motor speed-rise determining portion 110 is configured to determine whether an estimated speed N_{M12} upon completion or immediately after completion of the shifting action of the automatic transmission portion 20 is raised with respect to an estimated speed N_{M11} upon initiation or immediately before initiation of the shifting action. The estimated speed N_{M12} is calculated on the basis of the estimated engine speed N_{E2} upon completion of the shifting action of the differential portion 11, an estimated speed N of the second electric motor M2 upon completion of the shifting action of the automatic transmission portion 20 (N_{M2}=operating speed N_{OUT} of the output shaft 22 multiplied by the speed ratio of the gear position established after the shifting action of the automatic transmission portion 20), and the gear ratio ρ1 of the power distributing mechanism 16. The affirmative determination is obtained by the first-electric-motor speed-rise determining portion 108 when the estimated engine speed N_{M12} upon completion of the shifting action is raised with respect to the estimated speed N_{M11} upon or immediately before initiation of the shifting action.

The inertia phase determining portion 112 is configured to determine whether the shifting action of the automatic transmission portion 20 has entered an inertia phase. This determination is made by determining whether a change of the rotating speed N₁₈ of the power transmitting shaft 18 functioning as the input shaft of the automatic transmission portion 20 is initiated due to the shifting action. The rotating speed N₁₈ of the power transmitting shaft 18 is detected by a resolver (not shown) provided to detect the operating speed N_{M2} of the second electric motor M2 connected to the power transmitting member 18. When a change of the detected speed N_{M2} of the second electric motor M2, that,s the speed N₁₈ of the power transmitting member 18 is initiated, the inertia phase determining portion 112 obtains the affirmative determination that the shifting action of the automatic transmission portion 20 has entered or initiated the inertia phase.

The motor speed control portion 104 is provided to control the first electric motor M1 after the control of the first electric motor M1 by the feedback control portion 85 is inhibited by the feedback control inhibiting portion 102. The manner of control of the first electric motor M1 by the motor speed control portion 104 is changed depending upon the results of the determinations made by the engine speed rise determining portion 108 and the first-electric-motor speed-rise determining portion 110. To begin with, he manner of control of the first electric motor M1 where affirmative determinations are obtained by both of the engine speed rise determining portion 108 and first-electric-motor speed-rise determining portion 110 will be described.

Where the affirmative determinations are obtained by both of the engine speed rise determining portion 108 and first-electric-motor speed-rise determining portion 110 will be described, the direction of change of the estimated speed of the first electric motor M1 during the shifting action of the differential portion 11 is the same as the direction of change of the estimated speed of the engine 8 during the shifting action, that is, the estimated engine speed N_{E2} upon completion of the shifting action is raised with respect to the engine speed N_{E1} upon initiation of the shifting action, and the estimated speed N_{M12} upon completion of the shifting action is raised with respect to the estimated speed N_{M11} upon initiation of the shifting action. In this case, the motor speed control portion 104 raises the speed N_{M1} of the first electric motor M1 at a predetermined rate until the shifting action of the automatic transmission portion 20 has initiated or entered the inertia phase. The predetermined rate is determined by an amount of change of the speed N_{M1} during the shifting action, to be relatively low. The manner of control of the first electric motor M1 by the motor speed control portion 104 is changed after the inertia phase determining portion 112 has obtained an affirmative determination that the shifting action of the automatic transmission portion 20 has entered the inertia phase. Described in detail, after the entry of the inertia phase of the shifting action of the automatic transmission portion 20, the motor speed control portion 104 controls the operating speed N_{M1} of the first electric motor M1 according to the operating speed N_{M2} of the second electric motor M2, more specifically, changes the operating speed N_{M1} of the first electric motor M1 toward the estimated speed N_{M12} upon completion of the shifting action, at a rate corresponding to the rate of change of the operating speed N_{M2} of the second electric motor M2. In this respect, it is noted that the estimated speed N_{M2} of the second electric motor M2 upon completion of the shifting action of the automatic transmission portion 20 is obtained by multiplying the rotating speed N_{OUT} of the output shaft 22 of the automatic transmission portion 20 by the speed ratio of the gear position established after the shifting action. Therefore, the rate of change of the speed N_{M2} of the second electric motor M2 can be calculated.

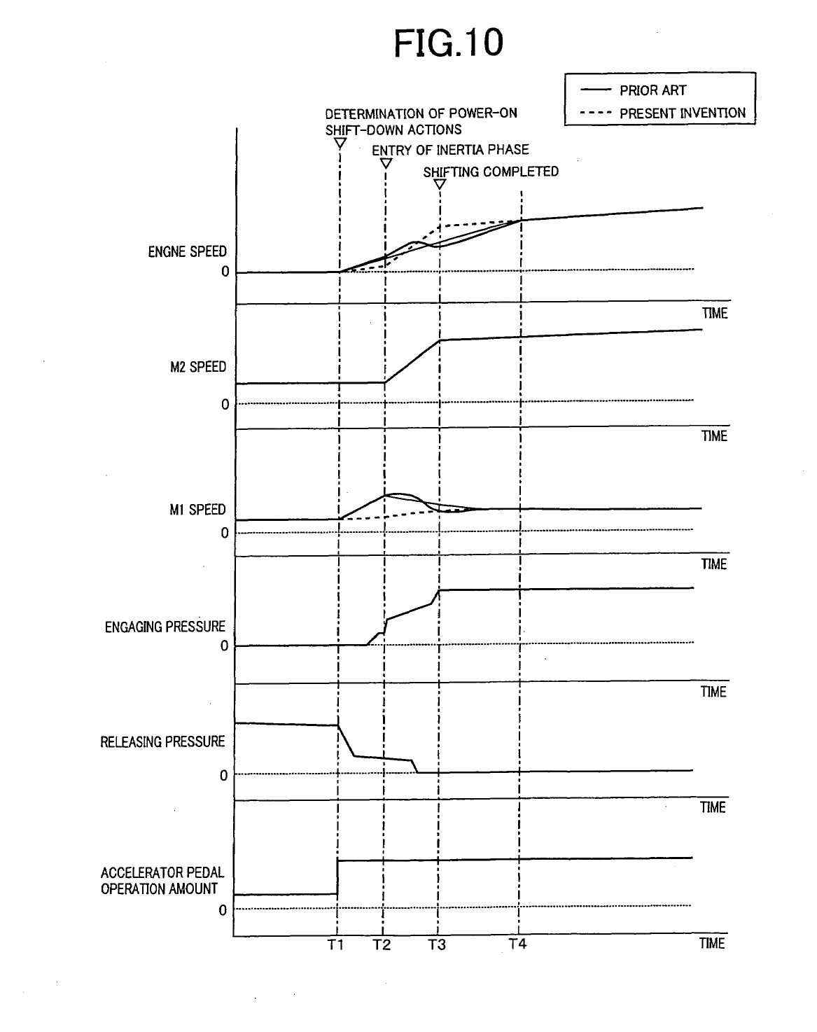

The control of the speed N_{M1} of the first electric motor M1 by the motor speed control portion 104 will be described referring to the time chart of FIG. 10, which explains one example of power-on shift-down actions of the differential portion 11 and the automatic transmission portion 20, which take place when the accelerator pedal is depressed. In this example, the operation amount A_{CC} of the accelerator pedal is increased by a depressing operation of the accelerator pedal at a point of time T1. As a result, concurrent power-on shifting actions of the differential portion 11 and automatic transmission portion 20 are initiated upon depression of the accelerator pedal, and the affirmative determination is obtained by the concurrent shifting determining portion 106 at the point of time T1. Accordingly, the feedback control of the first electric motor M1 by the feedback control portion 85 is inhibited by the feedback control inhibiting portion 102. After the affirmative determinations are obtained by the engine speed rise determining portion 108 and first-electric-motor speed-rise determining portion 110, the operating speed N_{M1} of the first electric motor M1 is raised at the predetermined rate for a period from the point of time T1 to a point of time T2. When the affirmative determination is obtained by the inertia phase determining portion 112 at the point of time T2, the first electric motor M1 is controlled to raise its speed N_{M1} toward the estimated speed N_{M12} at the rate corresponding to the rate of rise of the speed N_{M2} of the second electric motor M2, for a period from the point of time T2 to a point of time T4. During the control of the speed N_{M1} of the first electric motor M1, the speed N_{E} of the engine 8 is controlled as indicated by broken line.

Then, there will be described the manner of control of the speed N_{M1} of the first electric motor M1 by the motor speed control portion 104 where the affirmative determination is obtained by the engine speed rise determining portion 108 while the negative determination is obtained by the first-electric-motor speed-rise determining portion 110. In this case, the direction of change of the estimated speed of the first electric motor M1 during the shifting action of the shift-down actions of the differential portion 11 and automatic transmission portion 20 is opposite to the direction of change of the estimated speed of the engine 8. That is, the estimated engine speed N_{E2} upon completion of the shift-down actions is raised with respect to the engine speed N_{E1} upon initiation of the shift-down actions, while the estimated speed N_{M12} of the first electric motor M1 is lowered with respect to the estimated speed N_{M11} of the first electric motor M1 upon initiation of the shift-down actions. In this case, the motor speed control portion 104 holds the speed N_{M1} at a predetermined value until the affirmative determination is obtained by the inertia phase determining portion 112, that is, the shift-down action of the automatic transmission portion 20 has entered the inertia phase. For example, the predetermined value is the speed N_{M1} upon initiation of the concurrent power-on shift-down actions. When the affirmative determination is obtained by the inertia phase determining portion 112, the manner of control of the first electric motor M1 by the motor speed control portion 104 is changed. Described more specifically, the speed N_{M1} of the first electric motor M is controlled toward the estimated speed N_{M12} upon completion of the shift-down actions, according to the speed N_{M2} of the second electric motor M2.

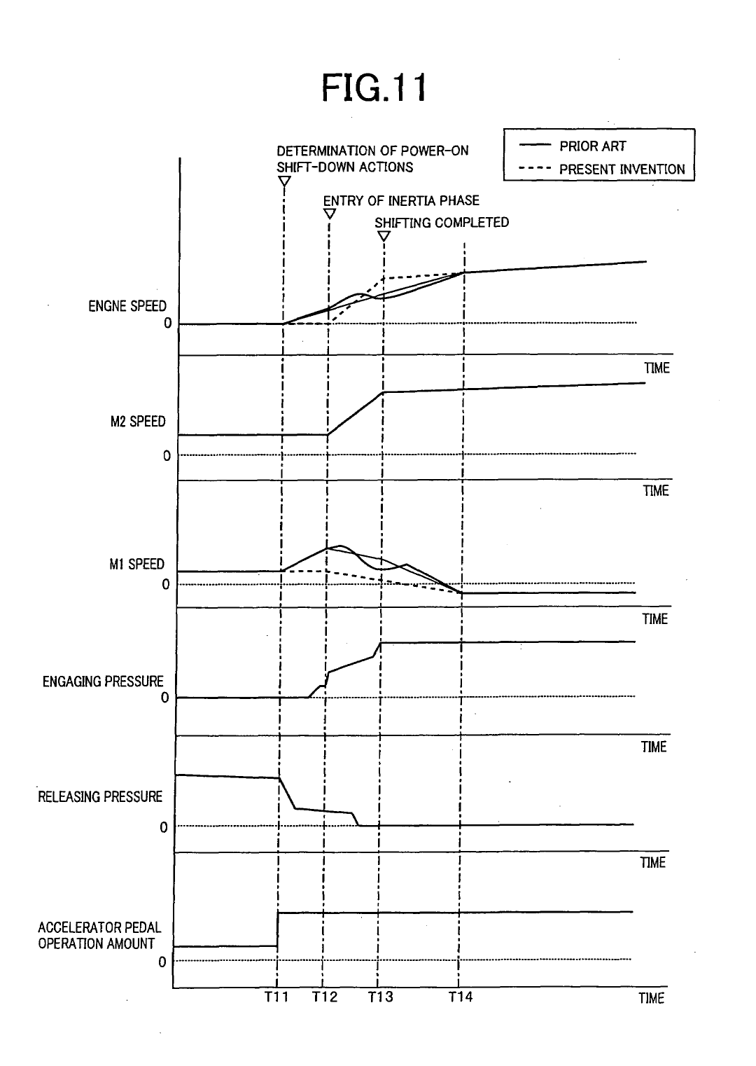

The control of the speed N_{M1} of the first electric motor M1 by the motor speed control portion 104 will be described referring to the time chart of FIG. 11, which explains another example of power-on shift-down actions of the differential portion 11 and the automatic transmission portion 20, which take place when the accelerator pedal is depressed. In this example, the operation amount A_{CC} of the accelerator pedal is increased by a depressing operation of the accelerator pedal at a point of time T11. As a result, concurrent power-on shifting actions of the differential portion 11 and automatic transmission portion 20 are initiated upon depression of the accelerator pedal, and the affirmative determination is obtained by the concurrent shifting determining portion 106 at the point of time T11. Accordingly, the feedback control of the first electric motor M1 by the feedback control portion 85 is inhibited by the feedback control inhibiting portion 102. After the affirmative determination is obtained by the engine speed rise determining portion 108 while the negative determination is obtained by the first-electric-motor speed-rise determining portion 110, the operating speed N_{M1} of the first electric motor M1 is held constant at a predetermined value (for example, at the value upon initiation of the shift-down actions) during a period from the point of time T11 to a point of time T12. When the affirmative determination is obtained by the inertia phase determining portion 112 at the point of time T12, the first electric motor M1 is controlled to raise its speed N_{M1} toward the estimated speed N_{M12} at the rate corresponding to the rate of rise of the speed N_{M2} of the second electric motor M2, for a period from the point of time T12 to a point of time T13. During the control of the speed N_{M1} of the first electric motor M1, the speed N_{E} of the engine 8 is controlled as indicated by broken line.

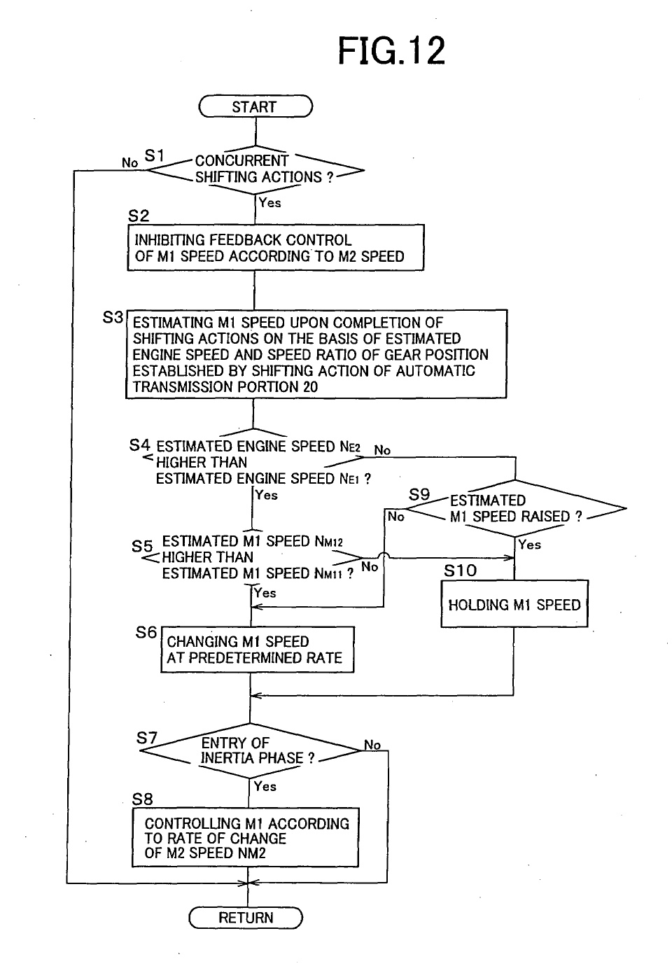

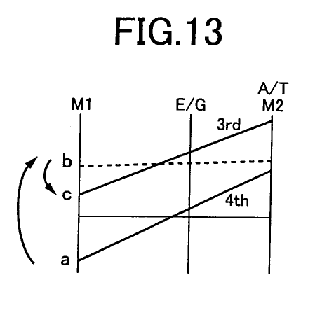

Referring next to the flow chart of FIG. 12, there will be described a control routine executed by the electronic control device 80 for reducing an unnecessary change of the operating speed N_{M1} of the first electric motor and reducing the shifting shock of the automatic transmission portion 20, upon concurrent shifting actions of the differential portion 11 and automatic transmission portion 20. This control routine is repeatedly executed with an extremely short cycle time of several milliseconds to several tends of milliseconds.

The control routine of FIG. 12 is initiated with step S1 corresponding to the concurrent shifting determining portion 106, to determine whether shifting actions of the differential portion 11 and automatic transmission portion 20 take place concurrently. If a negative determination is obtained in step S1, one cycle of execution of the present control routine is terminated. If an affirmative determination is obtained in step S1, the control flow goes to step S2 corresponding to the feedback control inhibiting portion 102, to inhibit the control of the first electric motor M2 according to the operating speed N_{M2} of the second electric motor M2. The control flow then goes to step S3 corresponding to the first-electric-motor speed-rise determining portion 110, to calculate the estimated speed N_{M12} of the first electric motor upon completion of the shifting actions, on the basis of the engine speed N_{E2} upon completion of the shifting actions, and the speed ratio of the gear position established after the shifting action of the automatic transmission portion 20. Then, the control flow goes to step S4 corresponding to the engine speed rise determining portion 108, to determine the estimated speed N_{E2} of the engine 8 upon completion of the shifting actions is raised with respect to the estimated engine speed N_{E1} upon initiation of the shifting actions, that is higher than the estimated engine speed N_{E1}. If an affirmative determination is obtained in step S4, the control flow goes to step S5 also corresponding to the first-electric-motor speed-rise determining portion 110, to determine whether the estimated speed N_{M12} of the first electric motor M1 upon completion of the shifting actions is raised with respect to the estimated speed N_{M11} upon initiation of the shifting actions, that is, higher than the estimated speed N_{M11}. If an affirmative determination is obtained in step S5, the control flow goes to step S6 corresponding to the motor speed control portion 104, to change the operating speed N_{M1} of the first electric motor M1 at the predetermined rate.

If a negative determination is obtained in step S4, the control flow goes to step S9 also corresponding to the first-electric-motor speed-rise determining portion 110, to determine whether the estimated speed N_{M12} of the first electric motor M1 upon completion of the shifting actions is higher than the estimated speed N_{M11} upon initiation of the shifting actions. If a negative determination is obtained in step S9, the control flow goes to the above-descried step S6 to change the operating speed N_{M1} of the first electric motor M1 at the predetermined rate. The step S6 is followed by step S7 corresponding to the inertia phase determining portion 112, to determine whether the shifting action of the automatic transmission portion 20 has entered or initiated the inertia phase. If a negative determination is obtained in step S7, one cycle of execution of the present control routine is terminated. If an affirmative determination is obtained in step S7, the control flow goes to step S8 to change the speed N_{M1} of the first electric motor M1 toward the estimated speed N_{M12} upon completion of the shifting actions, at a rate determined according to the rate of change of the speed N_{M2} of the second electric motor M2.

If a negative determination is obtained in step S5, or if an affirmative determination is obtained in step S9, the control flow goes to step S10 also corresponding to the motor speed control portion 104, to hold the speed N_{M1} of the first electric motor M1 constant at a suitable value. Step S10 is followed by the above-described step S7 to determine whether the shifting action of the automatic transmission portion 20 has entered the inertia phase. When the affirmative determination is obtained in step S7, the above-described step S8 corresponding to the motor speed control portion 104 is implemented to change the speed N_{M1} toward the estimated value N_{M12} upon completion of the shifting actions, at the rate determined according to the rate of change of the speed N_{M2} of the second electric motor M2.

The control apparatus in the form of the electronic control device 80 according to the present embodiment of the invention described above is configured such that the feedback control of the first electric motor M1 according to the operating speed N_{M2} of the second electric motor M2 is inhibited during the concurrent shifting actions of the electrically controlled differential portion 11 and the automatic transmission portion 20, making it possible to prevent an unnecessary change of the operating speed N_{M1} of the first electric motor M1 by the feedback control, which would take place due to a rapid change of the operating speed N_{M2} of the second electric motor M2 in the inertia phase of the shifting action of the automatic transmission portion 20. Thus, the present control apparatus is configured to reduce a variation of the input shaft torque of the automatic transmission portion 20, and a shifting shock of the automatic transmission portion 20.

The illustrated embodiment is further configured such that the feedback control of the first electric motor M1 according to the operating speed N_{M2} of the second electric motor M2 is inhibited during the shifting actions of the electrically controlled differential portion 11 and the automatic transmission portion 20 that cause a movement of the operating point of the engine 8. Accordingly, the control apparatus in the form of the electronic control device 80 according to the present embodiment makes it possible to prevent an unnecessary change of the operating speed N_{M1} of the first electric motor M1 by the feedback control, which would take place due to a rapid change of the operating speed N_{M2} of the second electric motor M2 during the shifting actions that causes the movement of the operating point of the engine 8. Thus, the present control apparatus is configured to reduce a variation of the input shaft torque of the automatic transmission portion 20, and a shifting shock of the automatic transmission portion 20.

The illustrated embodiment is also configured such that the operating speed N_{M1} of the first electric motor M1 is controlled so as to reduce the amount of change of the operating speed N_{M1} during the shifting actions of the differential portion 11 and the automatic transmission portion 20, making it possible to effectively reduce the unnecessary change of the operating speed N_{M1} of the first electric motor M1, so that the amount of the input torque variation of the automatic transmission portion 20 is minimized to reduce the shifting shock of the automatic transmission portion 20.

The control apparatus according to the illustrated embodiment is arranged such that the manner of controlling the first electric motor M1 is changed after the entry of the inertia phase of the shifting action of the automatic transmission portion 20, the operating speed N_{M1} of the first electric motor M1 can be controlled to the estimated operating speed N_{M12} upon completion of the shifting action, after the entry or initiation of the inertia phase of the shifting action, while preventing an unnecessary change of the operating speed N_{M1} of the first electric motor M1.

The illustrated embodiment is further arranged such that the operating speed N_{M1} of the first electric motor M1 is held at the predetermined value until the shifting action of the automatic transmission portion 20 has entered the inertia phase, if the direction of the estimated change of the operating speed N_{M1} of the first electric motor M1 during the concurrent shifting actions is different from the direction of the estimated change of the operating speed N_{E} of the engine 8 during the concurrent shifting actions. Accordingly, the operating speed N_{M1} of the first electric motor M1 can be smoothly changed while minimizing the amount of change, from a moment of initiation of the concurrent shifting actions to a moment of completion of the concurrent shifting actions, so that the shifting shock of the automatic transmission portion 20 can be reduced.

The illustrated embodiment is further configured such that the operating speed N_{M1} of the first electric motor M1 is changed at the predetermined rate until the shifting action of the automatic transmission portion 20 has entered the inertia phase, if the direction of the estimated change of the operating speed N M1 of the first electric motor M1 during the concurrent shifting actions is the same as the direction of the estimated change of the operating speed N_{E} of the engine 8 during the concurrent shifting actions. Accordingly, the operating speed N_{M1} of the first electric motor M1 can be smoothly changed while minimizing the amount of change, from a moment of initiation of the concurrent shifting actions to a moment of completion of the concurrent shifting actions, so that the shifting shock of the automatic transmission portion 20 can be reduced.

The illustrated embodiment is also configured such that the operating speed N_{M1} of the first electric motor M1 is controlled according to the operating speed N_{M2} of the second electric motor M2 after the shifting action of the automatic transmission portion 20 has entered the inertia phase. Accordingly, the operating speed N_{M1} of the first electric motor M1 after the entry of the inertia phase can be smoothly changed to the estimated value N_{M12} upon completion of the concurrent shifting actions, so that an unnecessary change of the operating speed N_{M1} of the first electric motor M1 is reduced to reduce the shifting shock of the automatic transmission portion 20.

The illustrated embodiment is further arranged such that the electrically controlled differential portion 11 is operable as the continuously-variable transmission mechanism while the operating state of the first electric motor M1 is controlled, so that a drive torque of the vehicle can be smoothly changed.

While the preferred embodiment of this invention has been described in detail by reference to the accompanying drawings, it is to be understood that the present invention may be otherwise embodied.

In the illustrated embodiment, the motor speed control portion 104 is configured to change the operating speed N_{M1} of the first electric motor M1 at a predetermined rate where the operating speed N_{E} of the engine 8 and the operating speed N_{M1} of the first electric motor M1 are both raised during the shifting actions of the differential portion 11 and automatic transmission portion 20. However, the motor speed control portion 104 may be configured to hold the speed N_{M1} at the value upon initiation of the shifting actions, until the shifting action of the automatic transmission portion 20 has entered its inertia phase.

In the illustrated transmission mechanism 10, the second electric motor M2 is connected directly to the power transmitting member 18. However, the second electric motor M2 may be connected to any portion of the power transmitting path between the differential portion 11 and the drive wheels 34, either directly or indirectly through a suitable transmission device.

Although the differential portion 11 functions as an electrically controlled continuously variable transmission the gear ratio γ0 of which is continuously variable from the minimum value γ0ₘᵢₙ to the maximum value γ0ₘₐₓ, the differential portion 11 may be modified such that its speed ratio γ0 is not variable continuously, but is variable in steps by utilizing its differential function. The present invention is applicable to a hybrid vehicle drive system including the differential portion modified as described above.

In the power distributing mechanism 16 in the illustrated transmission mechanism 10, the first carrier CA1 is fixed to the engine 8, and the first sun gear S1 is fixed to the first electric motor M1 while the first ring gear R1 is fixed to the power distributing member 18. However, this arrangement is not essential. The engine 8, first electric motor M1 and power transmitting member 18 may be fixed to any other elements selected from the three elements CA1, S1 and R1 of the first planetary gear set 24.

While the engine 8 is directly fixed to the input shaft 14 in the illustrated transmission mechanism 10, the engine 8 may be operatively connected to the input shaft 14 through any suitable member such as gears and a belt, and need not be disposed coaxially with the input shaft 14.

In the illustrated transmission mechanism 10, the first and second electric motors M1, M2 are disposed coaxially with the input shaft 14 such that the first electric motor M1 is connected to the first sun gear S1 while the second electric motor M2 is connected to the power transmitting member 18. However, this arrangement is not essential. For instance, the first electric motor M1 may be operatively connected to the first sun gear S1 through gears, a belt or a speed reduction device, while the second electric motor M2 may be connected to the power transmitting member 18.

In the illustrated embodiment, the automatic transmission portion 20 is connected in series to the differential portion 11 through the power transmitting member 18. However, the automatic transmission portion 20 may be disposed coaxially with a counter shaft disposed parallel to the input shaft 14. In this case, the differential portion 11 and the automatic transmission portion 20 are connected to each other through a suitable power transmitting member or members in the form of a pair of counter gears, or sprockets and a chain, such that a rotary motion can be transmitted between the differential portion 11 and the automatic transmission portion 20.

Further, the differential mechanism in the form of the power distributing mechanism 16 provided in the illustrated embodiment may be replaced by a differential gear device including a pinion rotated by the engine 8, and a pair of bevel gears which mesh with the pinion and which are operatively connected to the first electric motor M1 and the power transmitting member 18 (second electric motor M2).

While the power distributing mechanism 16 in the illustrated embodiment is constituted by one planetary gear set 24, it may be constituted by two or more planetary gear sets so that the power distributing mechanism 16 is operable as a transmission having three or more gear positions in the non-differential state (fixed-speed-ratio shifting state). The planetary gear sets are not limited to the single-pinion type, and may be of a double-pinion type. Where the power distributing mechanism 16 is constituted by two ore more planetary gear sets, the engine 8, first and second electric motors M1, M2 and power transmitting member 18 are operatively connected to respective rotary elements of the planetary gear sets, and the power distributing mechanism 16 is switched between its step-variable and continuously-variable shifting states, by controlling the clutches C and brakes B connected to the respective rotary elements of the planetary gear sets.

While the engine 8 and the differential portion 11 are connected directly to each other in the illustrated transmission mechanism 10, they may be connected to each other indirectly through a clutch.

In the illustrated transmission mechanism 10, the differential portion 11 and the automatic transmission portion 20 are connected in series to each other. However, the control apparatus according to the present invention is equally applicable to a drive system in which an electrically controlled differential portion and a step-variable transmission portion are not mechanically independent of each other, provided the drive system as a whole has an electric differential function, and a shifting function different from the electric differential function. Further, the electrically controlled differential portion and the step-variable transmission portion may be suitably disposed in a desired order in the drive system.

It is to be understood that the embodiment of the invention has been descried for illustrative purpose only, and that the present invention may be embodied with various changes and modifications which may occur to those skilled in the art.

What is claimed is:

1. A control apparatus for a vehicular power transmitting system including (a) an electrically controlled differential portion which has a differential mechanism and a first electric motor operatively connected to a rotary element of the differential mechanism and which is operable to control a differential state between a rotating speed of its input shaft connected to a drive power source and a rotating speed of its output shaft by controlling an operating state of the first electric motor, (b) a transmission portion constituting a part of a power transmitting path between the electrically controlled differential portion and a drive wheel of a vehicle, and (c) a second electric motor connected to the power transmitting path, said control apparatus comprising:
a feedback control inhibiting portion configured to inhibit a feedback control of said first electric motor according to an operating speed of said second electric motor, upon concurrent shifting actions of the electrically controlled differential portion and the transmission portion.

2. The control apparatus according to claim 1, further comprising a motor speed control portion configured to control an operating speed of the first electric motor so as to reduce an amount of change of the operating speed of the first electric motor during said concurrent shifting actions, on the basis of an estimated operating speed of the second electric motor upon completion of the shifting action of the transmission portion and an estimated operating speed of the drive power source upon completion of the shifting action of the transmission portion.

3. The control apparatus according to claim 2, wherein said motor speed control portion is configured to change a manner of controlling the first electric motor after an entry of an inertia phase of the shifting action of the transmission portion.

4. The control apparatus according to claim 2, wherein said motor speed control portion is configured to hold the operating speed of the first electric motor at a predetermined value until the shifting action of the transmission portion has entered an inertia phase, if a direction of an estimated change of the operating speed of the first electric motor during said concurrent shifting actions is different from a direction of an estimated change of the operating speed of the drive power source during the concurrent shifting actions.

5. The control apparatus according to claim 2, wherein said motor speed control portion is configured to change the operating speed of the first electric motor at a predetermined rate until the shifting action of the transmission portion has entered an inertia phase, if a direction of an estimated change of the operating speed of the first electric motor during said concurrent shifting actions is the same as a direction of an estimated change of the operating speed of the drive power source during the concurrent shifting actions.

6. The control apparatus according to claim 2, wherein said motor speed control portion is configured to control the operating speed of the first electric motor according to the operating speed of the second electric motor after the shifting action of the transmission portion has entered an inertia phase.

7. The control apparatus according to claim 1, wherein the electrically controlled differential portion is operable as a continuously-variable transmission mechanism while the operating state of the first electric motor is controlled.

8. The control apparatus according to claim 1, wherein the differential mechanism is a planetary gear set having three rotary elements consisting of a carrier connected to the input shaft of the electrically controlled differential portion, a sun gear connected to the first electric motor, and a ring gear connected to the output shaft of the electrically controlled differential portion.

9. The control apparatus according to claim 1 wherein said feedback control inhibiting portion permits said feedback control of said first electric motor according to the operating speed of said second electric motor, when the shifting actions of the electrically controlled differential portion and the transmission portion do not take place concurrently.

10. The control apparatus according to claim 1, wherein the vehicular power transmitting system has an overall speed ratio defined by a speed ratio of the transmission portion and a speed ratio of the electrically controlled differential portion.

11. The control apparatus according to claim 1, wherein the transmission portion is a mechanical automatic transmission.

12. A control apparatus for a vehicular power transmitting system including (a) an electrically controlled differential portion which has a differential mechanism and a first electric motor operatively connected to a rotary element of the differential mechanism and which is operable to control a differential state between a rotating speed of its input shaft connected to a drive power source and a rotating speed of its output shaft by controlling an operating state of the first electric motor, (b) a transmission portion constituting a part of a power transmitting path between the electrically controlled differential portion and a drive wheel of a vehicle, and (c) a second electric motor connected to the power transmitting path, said control apparatus comprising:
a feedback control inhibiting portion configured to inhibit a feedback control of said first electric motor according to an operating speed of said second electric motor, when shifting actions of the electrically controlled differential portion and the transmission portion that cause a movement of an operating point of said drive power source take place.

13. The control apparatus according to claim 12, further comprising a motor speed control portion configured to control an operating speed of the first electric motor so as to reduce an amount of change of the operating speed of the first electric motor during the shifting actions of the electrically controlled differential portion and the transmission portion, on the basis of an estimated operating speed of the second electric motor upon completion of the shifting action of the transmission portion and an estimated operating speed of the drive power source upon completion of the shifting action of the transmission portion.

14. The control apparatus according to claim 13, wherein said motor speed control portion is configured to change a manner of controlling the first electric motor after an entry of an inertia phase of the shifting action of the transmission portion.

15. The control apparatus according to claim 13, wherein said motor speed control portion is configured to hold the operating speed of the first electric motor at a predetermined value until the shifting action of the transmission portion has entered an inertia phase, if a direction of an estimated change of the operating speed of the first electric motor during the shifting actions of the electrically controlled differential portion and the transmission portion is different from a direction of an estimated change of the operating speed of the drive power source during the shifting actions.

16. The control apparatus according to claim 13, wherein said motor speed control portion is configured to change the operating speed of the first electric motor at a predetermined rate until the shifting action of the transmission portion has entered an inertia phase, if a direction of an estimated change of the operating speed of the first electric motor during the shifting actions of the electrically controlled differential portion and the transmission portion is the same as a direction of an estimated change of the operating speed of the drive power source during the shifting actions.

17. The control apparatus according to claim 13, wherein said motor speed control portion is configured to control the operating speed of the first electric motor according to the operating speed of the second electric motor after the shifting action of the transmission portion has entered an inertia phase.

18. The control apparatus according to claim 12, wherein the electrically controlled differential portion is operable as a continuously-variable transmission mechanism while the operating state of the first electric motor is controlled.

19. The control apparatus according to claim 12, wherein the differential mechanism is a planetary gear set having three rotary elements consisting of a carrier connected to the input shaft of the electrically controlled differential portion, a sun gear connected to the first electric motor, and a ring gear connected to the output shaft of the electrically controlled differential portion.

20. The control apparatus according to claim 19 wherein said feedback control inhibiting portion inhibits said feedback control of said first electric motor according to the operating speed of said second electric motor, when the shifting actions of the electrically controlled differential portion and the transmission portion do not cause a movement of the operating point of said drive power source.

21. The control apparatus according to claim 12, wherein the vehicular power transmitting system has an overall speed ratio defined by a speed ratio of the transmission portion and a speed ratio of the electrically controlled differential portion.

22. The control apparatus according to claim 12, wherein the transmission portion is a mechanical automatic transmission.
